(19) United States
(12) Patent Application Publication
(10) Pub. No.: US 2018/0089379 A1
(43) Pub. Date: Mar. 29, 2018

(54) HEALTHCARE CLAIM ANALYSIS NETWORK

(71) Applicant: HealthcarePays Network, LLC, Midlothian, VA (US)

(72) Inventors: Robert J. Collins, Brookfield, NH (US); David J. Adams, Midlothian, VA (US)

(21) Appl. No.: 15/479,425

(22) Filed: Apr. 5, 2017

Related U.S. Application Data
(60) Provisional application No. 62/399,028, filed on Sep. 23, 2016.

(51) Int. Cl. G06F 19/00; G06Q 10/10

(52) U.S. Cl. CPC G06F 19/328; G06Q 10/1057

(57) ABSTRACT

The present disclosure details a system for processing healthcare claims to detect fraud, waste and abuse (“FWA”) and facilitate automatic claim adjudication. The distributed system comprises a Claim Analysis Network (“CAN”) that analyzes claims based on a cumulative record of claims received from various independent claim sources. The CAN analyzes each claim using a network of analytics engines that individually analyze a claim according to respective rule-sets and algorithms concerning FWA and generate raw scores respectively. The CAN further processes the independent analytics results to generate a normalized, aggregate score for the claim and automatically enhances an electronic claim record with the scores and salient metadata from the analysis. In addition, the CAN algorithmically generates a routing decision facilitating claim payment or further claim investigation, as necessary, and automatically distributes the decision to an appropriate claim adjudication system for final adjudication.

### CROSS REFERENCE TO RELATED APPLICATION

The present application is based on and claims priority to U.S. Provisional Application No. 62/399,028, entitled HEALTHCARE CLAIM ANALYSIS NETWORK filed on Sep. 23, 2016, the contents of which is hereby incorporated by reference in its entirety.

### TECHNICAL FIELD OF THE INVENTION

This patent application relates generally to the field of healthcare claim processing systems, and, in particular, to computer-implemented systems and methods for automated processing of healthcare claims, as well as the automated identification, monitoring and reporting of fraud, waste and abuse.

### BACKGROUND OF THE INVENTION

Fraud, waste and abuse (“FWA”) are rampant in the U.S. healthcare payment system. Streamlining payment for healthcare services has been a significant focus of healthcare regulation and technology for the past couple of decades, with an eye toward minimizing payment latency and overhead throughout the healthcare payment ecosystem. The primary tactics to achieve these goals are standardization and automation. Standard data formats and protocols enable seamless integration and communication between the stakeholders, and automation reduces the labor cost and inherent latency introduced by having people involved in executing one or more steps of the primary payment workflow. Indeed, the regulatory framework that has evolved requires prompt payment of claims (through so-called prompt-pay regulations), encourages providers to utilize standards-compliant electronic communication and requires payers to support standards-compliant electronic communication and payment.

One of the possible payment workflows is shown in 11. FIG. 11 depicts an electronic payment workflow, starting with a patient visiting a provider through payment of the provider and delivery of the explanation of benefits (“EOB”) to the patient. This particular workflow depicts a self-insured employer paying for the services provided to the patient. Patient payments (co-pay, deductibles, etc.) are not depicted in FIG. 1. As shown, the patient visits the provider and receives services. The provider formulates one or more claims for reimbursement for services rendered by communicating with an intermediary or billing system/service, resulting in the transmission of claims in the standard EDI 837 file format to the claim adjudicator. The claim adjudicator examines the claim and determines the appropriate amount to pay; these funds are moved from the patient's employer's ERISA account to the provider's bank account. The details of the claim adjudication and associated payment are transmitted to the provider as an electronic remittance advice (“ERA”) EDI 835 format file and the patient receives a paper EOB in the mail.

The keys to automation in this example are the use of standard-compliant electronic file formats that are automatically sent, received and processed. The adjudication is implemented in an adjudication engine that manages all the contractual arrangements within the healthcare plan, as well as sets of rules that attempt to capture important patterns that define medical orthodoxy. The contractual arrangements determine whether the provider is in-network or out-of-network, the negotiated price for a procedure, the level of patient responsibility for the service, the patient's remaining deductible, etc. The rules that define medical orthodoxy might include the fact that men do not get gynecological exams, certain procedures are only appropriate in conjunction with particular diagnoses, etc. Claims that are incomplete or seem to contradict a medical orthodoxy rule are not paid and a request for corrections or additional documentation is transmitted to the provider; otherwise, the claim is paid.

As the industry has upgraded and migrated to newer technologies, the goals of reducing payment latency and reducing overhead via automation are being realized. Unfortunately, an unintended consequence has also been created: FWA claims are flowing through the system and getting paid at an unprecedented pace.

When claims were manually adjudicated, the human adjudicator was likely to notice and question, for example, a claim attempting to obtain reimbursement for two flu shots for the same patient, but such claims are automatically approved for payment by automated adjudication systems. Automated adjudication will pay such a claim, because the flu shot procedure code is covered by the plan. The only way that the automated adjudication system would stop payment for one of the flu shots is if it were specifically coded to look for improper duplicate procedures. Even if such a safeguard were in place, were the provider to claim the two flu shots in separate claims they both may well be paid if the anti-duplicate rule were not coded to look at all prior claims for the patient (which is a computationally expensive operation and requires significantly more sophisticated rules and infrastructure).

The transition from human adjudication (where one never knows what might pique the suspicions of an individual adjudicator) to automated, rule-based adjudication has paved the way for accelerated FWA by transitioning from non-deterministic to deterministic adjudication. In other words, if a particular pattern in a claim is approved once by an automated, deterministic adjudication engine, that pattern is always approved. Once a perpetrator of FWA learns the patterns and pitfalls, it is easy to submit claims that are automatically approved by such deterministic systems.

A widespread cottage industry of products and services is available to support providers in submitting claims and obtaining payment. One feature that is touted by many of these services is “claim edits,” which are basically sets of rules that tweak the details of a given claim prior to submission to the payer. These edits dramatically increase the likelihood that the claim is approved as submitted. While claim edits are a boon for well-meaning providers (because proper coding of claims can be a difficult task), they are also a boon for ensuring that FWA claims are not flagged during adjudication. Indeed, while adjudication systems claim to support the detection of FWA during adjudication, the implemented rules are not particularly robust and are completely defeated by pre-adjudication claim edits that automatically re-code claims that would otherwise trigger an FWA flag during adjudication.

The prompt-pay regulations are administered at the state level and generally apply to claims covered by an insurance policy sold by a payer. These regulations generally require payment of “clean” claims within 30 to 45 days of receipt of the claim, with violations resulting in significant penalties and interest payments. While requests for additional documentation from the provider pauses the prompt-pay clock, payers tend to perform little or no pre-payment FWA investigation and instead rely on post-payment investigation. Accordingly, as things stand today the primary strategy used against FWA is referred to as pay and chase.

According to pay and chase, claims are adjudicated and paid within the prompt-pay required timeframe. Months after payment remittance, such claims are examined and questionable claims are investigated in an attempt to recover funds for improperly paid claims. Generally, pay and chase is periodically applied to a payer's claims and the analysis is performed in the context of just those claims. In practice, recovery of improper payments during the “chase” phase of this strategy is not very effective because the perpetrators (and/or the money) are long gone by the time the investigation is complete.

As part of this process, an FWA investigator must decide which claims to examine or otherwise investigate. Usually, such claims are chosen on the basis of utilization rankings: claims associated with the most expensive patients or the providers that billed the most in aggregate or per-patient. While utilization focuses the attention where the money is being spent, it completely misses (and therefore emboldens) all but the most aggressive perpetrators of FWA. Moreover, the use of utilization to guide the focus of the investigative resources is not well-suited to the investigation of claims prior to payment because utilization computations are typically made over a window that spans several months preceding the investigation. This means that by the time a patient or provider rises to the top of the utilization chart, most of the claims have already been paid. Pre-payment investigation of the subsequent claims of these top users may be beneficial, but a huge opportunity has been lost with regard to the prior claims.

By contrast, more sophisticated FWA investigations generally utilize data analytics to help guide the investigator. The role of data analytics technologies in anti-FWA efforts is to help identify the likely “needle in the haystack”—in other words, to focus investigative effort on the most questionable reimbursement claims. The technologies include rule-based systems and machine learning models.

In a rule-based system, a group of experts defines a set of rules that are applied to a claim or a set of claims. For example, a set of rules might define the set of medical procedures that are appropriate in the context of a particular diagnosis; any claims related to procedures that are outside of this rule set might be flagged for investigation. In a rule-based system, rules have traditionally been authored based on medical orthodoxy. However, in some cases previously identified FWA behavior is the inspiration for new rules. In other words, once a fraud scheme has been identified, a set of rules might be crafted to detect similar schemes among the other claims that are being analyzed.

Machine learning is a broad category of methodologies that attempt to detect items of interest from a large set of granular data, with little or no input from domain experts. For example, one methodology that may be employed in anti-FWA efforts is anomaly detection. An anomaly detection system examines and characterizes the distribution of data values across dozens to hundreds of dimensions and the correlation between dimensions. Without any built-in understanding of the semantics of any of the dimensions, the system can identify those data values (in this case healthcare claims) that are outliers from the bulk of the data values. To illustrate the concept, consider that the typical colonoscopy procedure in the data set might be $3,000; the system would be able to flag a claim for a $30,000 colonoscopy without anyone having told it what a colonoscopy is or how much it ought to cost. In practice, these techniques can correlate across any number of dimensions. For example, the analytics might highlight a claim for reimbursement for a procedure as warranting further investigation when an unexpected combination of the following dimensions is encountered:
Physician with a particular specialty
Patient gender
Patient age
Diagnosis
A prior procedure that had been performed
The claimed procedure

The machine learning techniques utilize prior data to determine relevant combinations of dimensions and expected distributions, thereby allowing for the identification or detection of anomalies or outliers.

Another machine learning methodology uses prior data to build models that can classify new data elements. The general idea of these approaches when applied to FWA in healthcare claims is to take historical claims in conjunction with the outcome of historical FWA investigations of those claims to construct a model that attempts to classify a novel claim as to whether or not it likely constitutes FWA. The idea here is to train a model based on the historical data; this “learning” process determines which data dimensions (and combinations of dimensions) are positively and negatively correlated with a determination of FWA. Like anomaly detection systems, classification systems require a representative corpus of prior claim data in addition to target classification results to train the model.

Greater data density enables more useful analytics through the “network effect” (a phenomenon whereby a good or service becomes more valuable when more people use it). For example, if a particular payer sees one claim per month from a particular provider, the payer's analytical model of that provider's behavior has little data to work with and is unlikely to provide any useful insights. If the analytical model sees nearly all of the provider's claims, however, the model is likely to provide deep insights into the provider's patterns of behavior. In practice, the efficacy of machine learning techniques applied in the context of one particular payer is severely limited by insufficient data density.

In the context of data analysis, the proper handling and protection of healthcare claim data is an important consideration. The Health Insurance Portability and Accountability Act of 1996 (“HIPAA”) and related statues and regulations require proper handling of personal health information (“PHI”) to protect patient privacy. Any entity that creates PHI, such as a provider, is known as a covered entity, whereas any entity that receives PHI from a covered entity is known as a business associate. A contract, known as a business associate agreement (“BAA”), is required between the covered entity and the business associate, and a business associate may contract with further downstream business associates (under another BAA) to handle PHI. Among other things, the BAA stipulates how the PHI will be handled and how it may be used. Any entity that receives, stores or processes PHI incurs significant compliance risk and associated costs.

In addition to the foregoing, another significant statute that is relevant to the receipt and processing of healthcare claims is the Employee Retirement Income Security Act of 1974 (“ERISA”), which applies to many larger employer-based health plans. ERISA places a legal requirement to not make healthcare reimbursements unless there is proof that the claim is legitimate. In addition, ERISA makes plan fiduciaries personally liable for any inappropriate disbursements of funds, which includes the payment of any healthcare claims that would be characterized as FWA.

Current healthcare FWA detection is of limited efficacy for several reasons. For instance, FWA analysis and investigation is performed after the claims have been paid. Post-payment detection allows improper payments to continue and recovery of improper payments is often difficult or impossible. In addition, filtering of claims for investigation based on utilization and rule-based systems allow the more-sophisticated and less-aggressive schemes to go undetected. Moreover, machine learning-based claim investigation filters have limited efficacy due to low data density.

It is with respect to these and other considerations that the disclosure made herein is presented.

### SUMMARY OF CERTAIN EMBODIMENTS OF THE DISCLOSURE

Technologies are presented herein for a computer implemented method for algorithmically processing healthcare claim records to detect fraud, waste and abuse (“FWA”) and for enhancing the healthcare claim records to facilitate claim adjudication using an independent and distributed claim analysis computing network. The method comprises the step of receiving healthcare claims at a claim analysis network (“CAN”) computing device. The healthcare claims are received over a network from a respective claim source among a plurality of independent claim sources. The CAN comprises a memory, instructions in the form of code stored in the memory and a processor configured by executing the code. In addition, the CAN has access to a claim data store containing a plurality of records concerning previously processed claims and an identity data store containing a plurality of person records concerning persons associated with one or more of the previously processed claims.

The method in accordance with the present embodiment further comprises the step of processing a given received claim by the CAN. In particular, processing the received claim comprises the step of identifying, with the processor of the CAN, a person identified in the received claim and generating a claim record based on the received claim in the claim data store. The method also comprises the step of analyzing the claim record against a set of rules pertaining to indicators of fraud, which may include or otherwise compromise FWA, and generating one or more results based on the analysis. The analysis is performed using an analytics network that comprises a plurality of analytics engines. The method also comprises the step of automatically enhancing, by the configured processor of the CAN, the claim record in the claim data store according to the one or more generated results. In addition, the method comprises the step of generating a routing decision for the claim based on the one or more results and with respect to one or more routing rules. In particular, the routing decision is selected from the group consisting of a first routing decision directing a respective processing subsystem to pay the received claim, and a second routing decision directing the received claim to an investigative processing subsystem (“SIU”) thereby prompting further investigation of the received claim using the SIU. The method further comprises the step of distributing the enhanced claim record to a respective processing subsystem of a respective claim source according to the routing decision, thereby prompting further investigation of the claim by the respective claim source.

According to a further aspect, a system for analyzing healthcare claims for indicia of FWA and automatically adjudicating the healthcare claims is provided. In particular, the system comprises a claim analysis network server (“CAN”) for processing healthcare claims that are received over a network connection from a respective claim source among a plurality of claim sources. The CAN comprises a memory having stored instructions in the form of code, a hardware processor configured by executing the code, and a communications interface. In addition, the CAN has access to a claim data store containing a plurality of records concerning previously processed claims, and an identity data store containing a plurality of person records concerning persons associated with one or more of the previously processed claims.

The system also comprises an analytics network, which comprises one or more analytics engines that are selected from the group consisting of an analytics engine that is configured locally at the CAN, and a remote analytics engine. The CAN further comprises a plurality of functional modules implemented by the processor of the CAN to process a given received claim. The modules comprise a de-identification module that is operative to identify, using the identity data store and claim data store, a person identified in the received claim and generate a de-identified version of the claim. The modules also comprise a data management module that is operative to generate a claim record in the claim data store based on the received claim and enhance the claim record according to further analysis of the received claim using the CAN. Moreover, the modules comprise an analytics module that is operative to coordinate the analysis of the claim record by one or more analytics engines of the analytics network. In particular, the analytics engines are configured to analyze the claim record according to a set of rules pertaining to indicators of FWA and respectively generate a result based on the analysis.

The modules also comprise a claim router module that is operative to generate a routing decision for the received claim. In particular, the routing decision comprises one or more of a first routing decision directing a respective processing subsystem to pay the received claim, and a second routing decision directing an investigative processing subsystem to further investigate the received claim. In addition, the routing decision is generated according to a prioritization algorithm that is a function of the score for the received claim, a value of the received claim and an estimated cost of investigating the received claim. In addition, the modules comprise a communication module that is operative to configure the processor to, based on the routing decision, distribute the claim record and the routing decision to an appropriate processing subsystem of a respective source of the received claim.

These and other aspects, features, and advantages can be appreciated from the accompanying description of certain embodiments of the invention and the accompanying drawing figures and claims.

### BRIEF DESCRIPTION OF THE DRAWINGS

FIG. 1 is a high-level block diagram illustrating an exemplary configuration of a system for processing healthcare claims in accordance with at least one embodiment disclosed herein;

FIG. 2 is a high-level block diagram illustrating an exemplary dataflow between a healthcare claim adjudicator system and a claim analysis network (“CAN”) of FIG. 1 in accordance with at least one embodiment disclosed herein;

FIG. 3 is a high-level block diagram illustrating an exemplary dataflow between components of the healthcare claim adjudicator system and the CAN of FIG. 1 in accordance with at least one embodiment disclosed herein;

FIG. 4 is a high-level block diagram illustrating an exemplary dataflow between the claim analysis network and external computing devices of FIG. 1 in accordance with at least one embodiment disclosed herein;

FIG. 5 is a high-level block diagram illustrating an exemplary configuration of the CAN of FIG. 1 and an exemplary data flow within the CAN while processing a claim in accordance with at least one embodiment disclosed herein;

FIG. 6 is a high-level block diagram illustrating an exemplary configuration of the CAN of FIG. 1 and an exemplary data flow within the CAN in accordance with at least one embodiment disclosed herein;

FIG. 7 is a high-level block diagram illustrating an exemplary configuration of the CAN of FIG. 1 and an exemplary data flow within the CAN in accordance with at least one embodiment disclosed herein;

FIG. 8 is a high-level block diagram illustrating an exemplary data flow from the CAN of FIG. 1 in accordance with at least one embodiment disclosed herein;

FIG. 9 is a high-level block diagram illustrating an exemplary configuration of an analytics module of the CAN of FIG. 1 and an exemplary data flow when analyzing a claim by the analytics module and external analytics providers in accordance with at least one embodiment disclosed herein;

FIG. 10 is a conceptual diagram illustrating a relational database schema and data structures maintained using the CAN of FIG. 1 in accordance with at least one embodiment disclosed herein;

FIG. 11 is a high-level diagram illustrating an exemplary electronic payment workflow that is conventional in the art; and

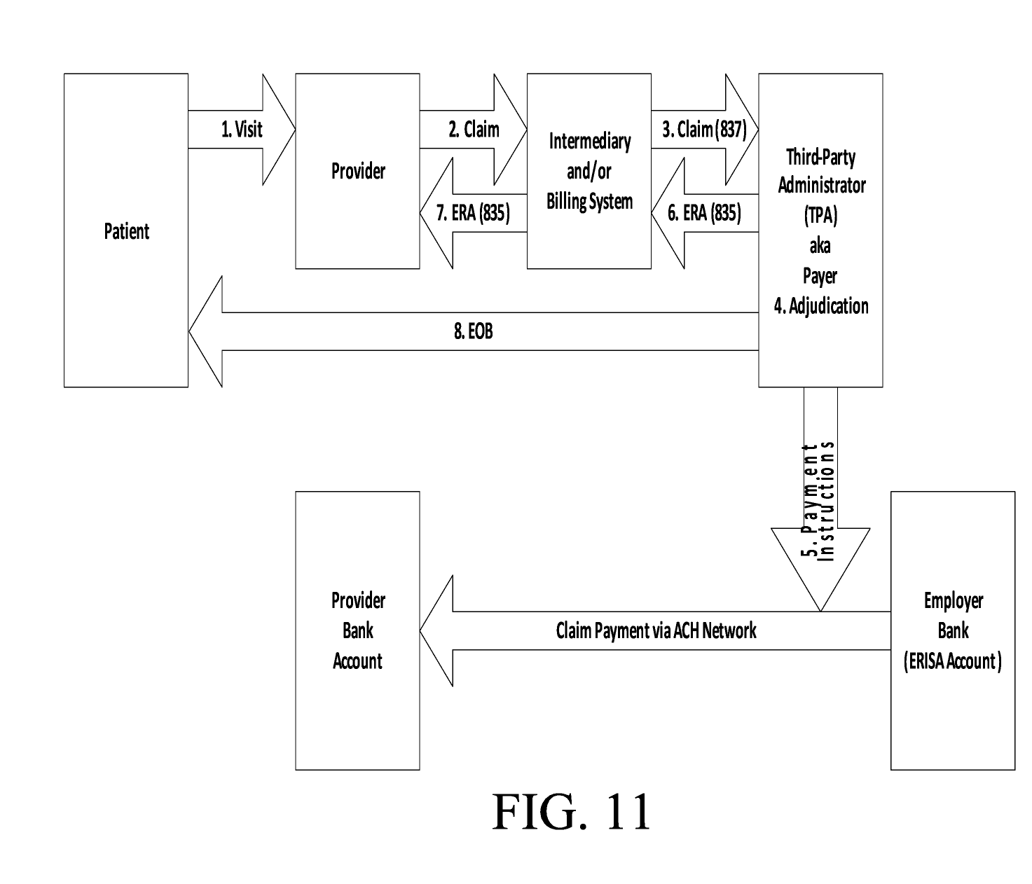

FIG. 12 is a block diagram illustrating an exemplary system configuration of the CAN of FIG. 1 in accordance with at least one embodiment disclosed herein.

### DETAILED DESCRIPTION OF CERTAIN EMBODIMENTS OF THE INVENTION

By way of overview and introduction, the present disclosure details a system for processing healthcare claims to detect fraud, waste and abuse (“FWA”). The system comprises a Claim Analysis Network (“CAN”) that, in some configurations, is implemented as a computer software system running on computer hardware infrastructure, which may comprise a distributed hardware architecture.

More specifically, the CAN in certain embodiment is arranged to receive healthcare claims electronically prior to payment such that each claim is sent to the CAN for analysis. According to a salient aspect, the CAN maintains a data store that combines healthcare claims received from multiple independent healthcare claim sources to maximize data density and leverage the network effect thereby providing improved detection and prevention of FWA. In particular, the CAN is configured to maintain an electronic claim record for the received healthcare claims. The CAN is further configured to combine related claim records (e.g., logically associates the records, as appropriate) by de-identifying the claims and associating them with canonical identifiers that can be mapped across any number of different claim sources. The CAN is further configured to periodically update and reconcile claim records as new information for a particular claim, patient and/or insured person is received from information sources (e.g., data feeds, claim feeds and the like).

According to another salient aspect, the CAN is configured to coordinate analysis of each claim for FWA using a distributed computing network. In certain embodiments, the CAN incorporates a network of internal and independent analytics providers. Each claim analytics provider comprises an analytics engine that can process a claim according to a respective rules-base and algorithmic solution for detecting fraud waste and abuse. The distributed and independent network serves to improve the detection of FWA and the selection of claims that are suitable for further FWA investigation. According to a salient aspect, in some implementations, the analysis of a particular claim can be performed based on other previously received claims that relate to the particular claim, say, claims that concern the same patient or insured person. Because the CAN is configured to receive and maintain records of claims received from various independent claim sources, a particular claim can be analyzed based on previously processed related claims irrespective of whether the analyzed claims were received from different claim sources.

The CAN is also configured to enhance the claim records based on the analysis of respective claims. For instance, in certain embodiments the CAN stores, in each claim record, raw scores generated by the analytics providers and related metadata, say, salient indicators of FWA uncovered during the analysis of respective claims. Accordingly, the enhanced records can inform further processing and investigation of respective claims and can improve the subsequent analysis of other claims. In addition, according to a salient aspect, the CAN is configured to evaluate and reconcile the results generated by one or more of the independent analytic providers for a respective claim and issue a routing determination instructing whether the respective claim should be immediately paid or subjected to additional investigation. The routing determination can be transmitted to the respective claim source and, more specifically, an appropriate processing subsystem, and can also comprise the enhanced claim record thereby facilitating further processing of the claim, as necessary, by the claim processing subsystem.

The CAN is also configured in certain embodiments to receive any final decision that results from any further investigation of a respective claim. Accordingly, the respective claim record can be further enhanced with the investigation decision. In addition, the decisions can be included in performance reports and used by the CAN and the distributed network of analytics providers to automatically adjust the algorithmic solutions to improve future FWA detection.

The referenced systems and methods for processing healthcare claims and detecting FWA are now described more fully with reference to the accompanying drawings, in which one or more illustrated embodiments and/or arrangements of the systems and methods are shown. The systems and methods are not limited in any way to the illustrated embodiments and/or arrangements as the illustrated embodiments and/or arrangements described below are merely exemplary of the systems and methods, which can be embodied in various forms, as appreciated by one skilled in the art. Therefore, it is to be understood that any structural and functional details disclosed herein are not to be interpreted as limiting the systems and methods, but rather are provided as a representative embodiment and/or arrangement for teaching one skilled in the art one or more ways to implement the systems and methods. Accordingly, aspects of the present systems and methods can take the form of an entirely hardware embodiment, an entirely software embodiment (including firmware, resident software, micro-code, etc.), or an embodiment combining software and hardware. One of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer. Furthermore, the terms and phrases used herein are not intended to be limiting, but rather are to provide an understandable description of the systems and methods.

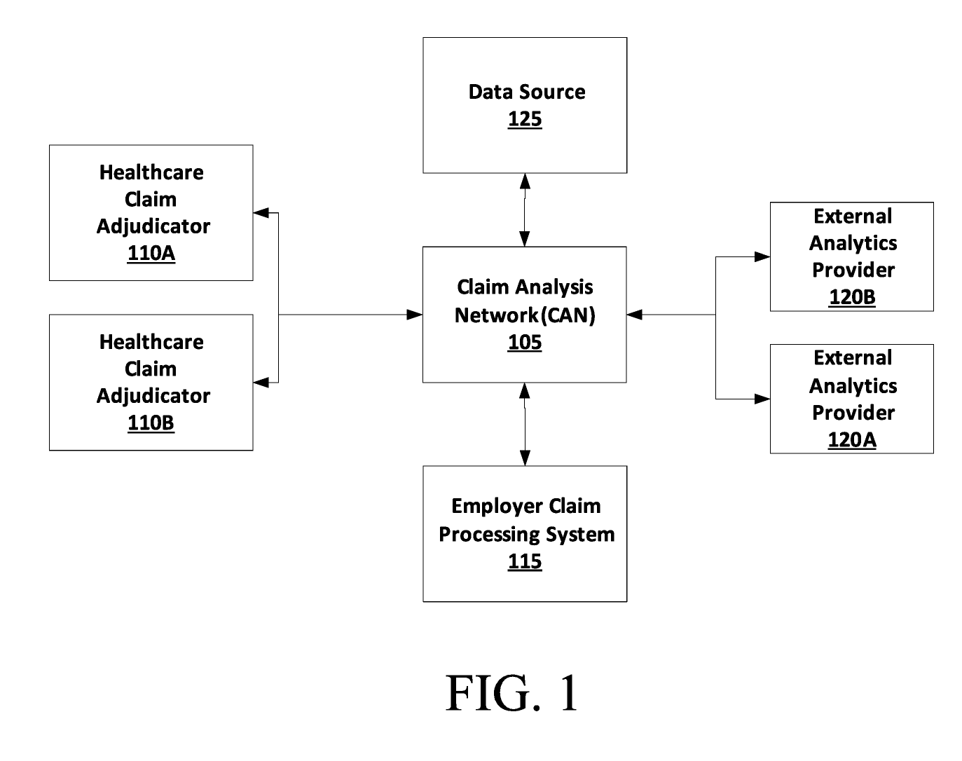

An exemplary system for processing healthcare claims and detecting FWA 100 is shown as a block diagram in FIG. 1. In this arrangement, the system 100 consists of the CAN computing system 105 (referred to herein as the CAN). Also shown are independent and remotely located computing systems in communication with the CAN 105 including Healthcare Claim Adjudicator computing systems 110A and 110B (referred to as Healthcare Claim Adjudicators) and Employer Claim processing system 115 (referred to as Employer Claim System). The CAN is also shown in communication with other remote computing systems such as third-party analytics provider systems 120A and 120B (referred to as Analytics Providers). The CAN can also be in communication with one or more data storage devices or data sources 125.

The CAN 105 and the systems in communication therewith are each intended to represent various forms of digital computing devices and/or data processing apparatus such as servers, blade servers, mainframes, and other appropriate computers and/or networked or cloud based computing systems that are capable of communicating with remote computing devices, data storage devices and computing networks, including receiving, transmitting and storing electronic information, as well as processing information as further described herein.

Such systems can be connected to and in communication with one-another and the CAN 105 directly or indirectly, for instance over a computer network (not shown) such as a local area network (“LAN”) or a wide area network (“WAN”) or the Internet. Moreover, although the system 100 is described in reference to a number of individual devices, it should be understood that the system is configured to interact with any number of such remote computing devices and users.

### Identification

According to a salient aspect, the CAN 105 receives healthcare claims from a variety of different and independent healthcare claim sources such as the Healthcare Claim Adjudicators 110A-110B and Employer Claim System 115. Furthermore, the CAN is configured to perform the function of patient identification irrespective of the respective source of each claim thereby facilitating identification of FWA across independent sources.

More specifically, the CAN according to certain embodiments receives healthcare claims from many claim sources and can analyze claims in the context of all others, regardless of source. By creating a network of claim sources, the CAN achieves the following non-exclusive benefits: crosses the traditional barriers that limit data density and volume formed by corporate boundaries (e.g., currently, payers do not share or pool data to prevent FWA); and crosses the traditional barriers formed by patients changing employers or employers changing health plans, creating a lifetime view for all patients.

In accordance with certain embodiments, which may comprise combinations of embodiments, the CAN implements strong identification procedures, as would be understood by those in the art, in identifying the patient associated with each claim. For example, the CAN is configured to create, in storage, a map associating patient identifiers that are specific to respective claim sources, with the patient's social security number. The CAN is further configured to access and/or maintain cumulative records of processed claims associated with the identified patients. Accordingly, the CAN is configured to create a unified view of all claims related to the care of the patient. The process of strong identification implemented by the CAN creates an association between all of the ways of referring to a particular person to a single identifier.

More specifically, a particular person may be known by various different names or identifiers (aliases) and has a multitude of “member numbers” that are assigned in the context of various insurance plans at any given time and over time as plan enrollments change. Through strong identification, the CAN accumulates a complete view into the patient's health and treatment across all types of claims, across all insurance plans, across changes in employer, etc.

The congregation of claims across many sources combined with strong identification by the CAN results in a uniquely comprehensive view into each patient's claim history and across a significantly larger population of patients than is possible without such a network. Similarly, a more comprehensive view of provider behavior is exposed. These comprehensive views and larger data set creates an unprecedented opportunity for effective analytics to focus the investigative resources on the proper set of claims in order to prevent payment of FWA claims.

Another aspect to the identification procedures is a procedure for the creation of a de-identified view of a given healthcare claim. In the context of HIPAA-related privacy regulations and compliance risks, limiting the propagation and proliferation of PHI is an important and valuable consideration and FWA analytics do not generally depend, for example, on the exact name and address of the patient. More specifically, HIPAA-related regulations consider the PHI to have been removed from a claim if one cannot determine the patient identity from the claim information (even in conjunction with additional data). The de-identification procedure follows HIPAA-related guidelines to constrain the propagation of PHI while minimally degrading the analysis of claims for FWA.

### Analytics Network

According to another salient aspect, the CAN incorporates an analytics network consisting of multiple analytics provider systems. “Analytics provider system” is intended to refer to computing systems and/or algorithmic engines configured to analyze claims, for instance, to detect FWA. The analytics provider system can, in some configurations, be internal to the CAN. In addition or alternatively, and more typically, the analytics provider system can be an independent system that is remote to the CAN 105 and is associated with a respective analytics provider (e.g., Analytics Provider system 120A and 120B). Such analytics provider systems (both internal and external to the CAN) can be utilized by the CAN to perform one or more of the claim analytics functions, as further described herein.

A distributed analytics network as maintained, controlled and coordinated using the CAN 105 provides key features and benefits, including:
Lowers barriers to entry into the healthcare marketplace for analytics providers. Currently, lack of data creates a significant barrier to entry for a new analytics provider. Without sufficient data, the analytics perform poorly; with poorly performing analytics, it is hard to get customers; without customers, it is hard to obtain sufficient data.
Creates a competitive marketplace for analytics with a level playing field as, all analytics providers can be provided access to all historical claims and investigation decisions. Also, higher-performing analytics providers tend to receive more revenue for participating in the network due to increases in work load or compensation.
Alleviates privacy concerns by avoiding the proliferation of personal health information as de-identified information can be shared with the analytics providers by the CAN 105, which retains and manages all protected health information (“PHI”) within the CAN.

The CAN 105 can be configured to integrate with any number of independent claim sources as part of the analytics network. The number of healthcare claim sources that can provide healthcare claims to the CAN for analysis is essentially unlimited, up to the size of the healthcare market. The ability to integrate unlimited sources of healthcare claims combined with independent and internally implemented analytics systems that improve with increased data density creates a virtuous cycle; as more claims are acquired for analysis, the analysis grows more effective and as the analysis grows more effective, the more claims (customers) that are acquired due to the increased value derived from participation in the CAN. While the virtuous cycle exists with CAN-internal analytics alone, the competitive nature facilitated by the distributed analytics network coordinated by the CAN, along with increased opportunity to participate due to lowered barriers to entry, serve to accelerate the virtuous cycle.

### Scoring

According to another salient aspect the CAN 105 is specifically configured to coordinate the processing and analysis of claims to detect FWA and facilitate the adjudication of claims accordingly. A given claim can be analyzed and assigned a score by the CAN or under the direction of the CAN 105. For instance, as further described herein the score can be an integer in the range of zero to 999, where higher scores represent a greater likelihood that further investigation of the claim will result in a reduction in the reimbursement to the provider. Score values can be relative and do not directly imply a likelihood of the claim being found to be FWA. However, the CAN 105 can be configured to compute a mapping of score to likelihood of an investigation resulting in the determination that the claim is FWA based on past scores and investigation outcomes. In some implementations, the CAN does not perform the investigation—such that investigation of a flagged claim is left to the respective claim source. Accordingly, in such a configuration, the score-to-FWA-likelihood mapping can be computed on a per-claim-source basis.

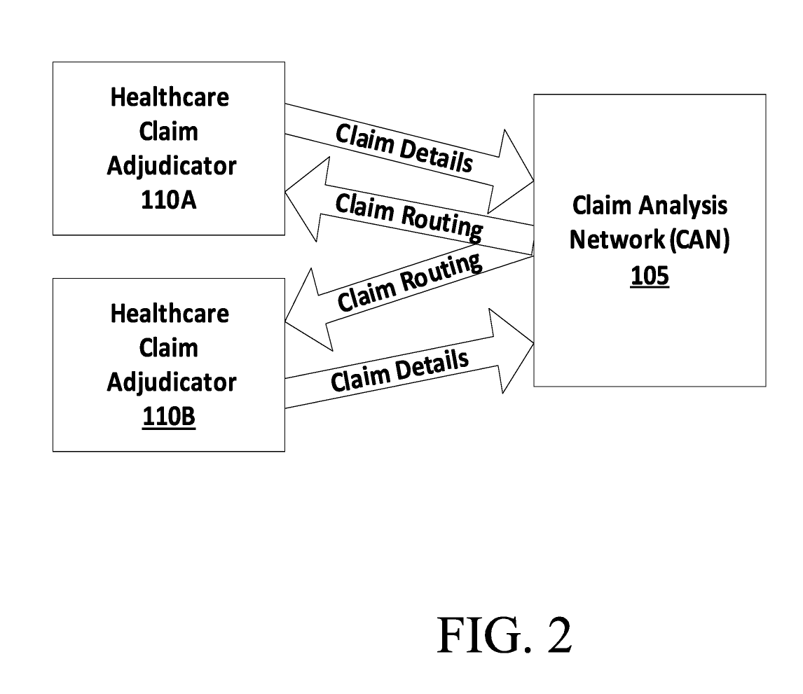

FIG. 2 is a high-level diagram illustrating an exemplary data flow between multiple Healthcare Claim Adjudicators and the CAN 105 in accordance with one or more embodiments of the invention. As illustrated in FIG. 2, the CAN 105 is configured to receive claims from one or more healthcare claim adjudicator systems 110A and 110B. For example and without limitation, such systems can be implemented by or on behalf of claim payers or third-party plan administrators. Using the information provided in the received claims, each claim is analyzed using the CAN and, based on the analysis, a claim routing directive is returned by the CAN to a respective claim adjudicator. The claim routing directive is an electronic message that indicates whether the claim should be subject to further pre-payment investigation or should be paid.

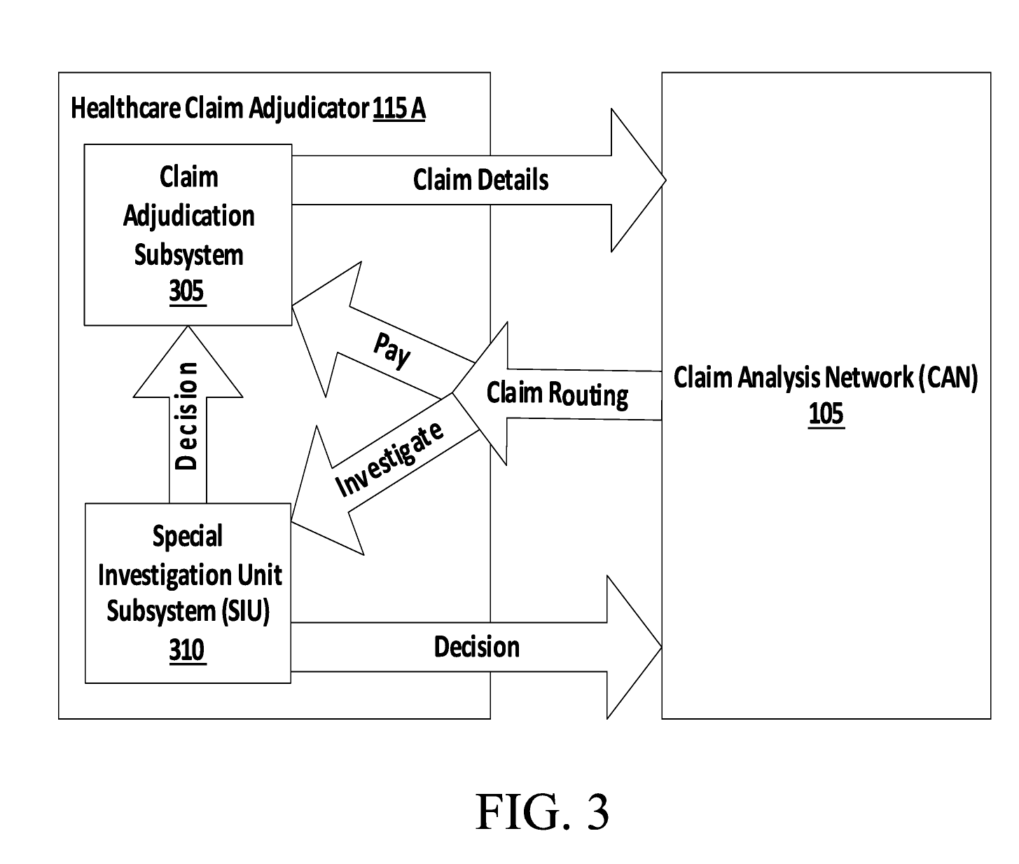

An exemplary dataflow between the CAN 105 and a particular Healthcare Claim Adjudicator (e.g., 115A) in accordance with one or more embodiments of the invention is illustrated in greater detail in FIG. 3. FIG. 3 also illustrates an exemplary configuration of the Healthcare Claim Adjudicator 115A in greater detail. As shown, the CAN 105 can be configured to interface with multiple aspects of a healthcare claim adjudicator's system, for instance, a Claim Adjudication Subsystem 305 and Special Investigation Unit (“SIU”) Subsystem 310.

More specifically, the Claim Adjudication Subsystem 305 can be configured to transmit the detail of each claim to the CAN 105. In response to receipt of the claim, the CAN is configured to make a claim routing determination, as further described herein. If the CAN determines that the claim should be paid, the Claim Adjudication Subsystem 305 is informed so the claim can be released for payment. For example, the CAN 105 can transmit a “pay” message to the Claim Adjudication Subsystem. If the CAN determines that the claims should be investigated, the SIU Subsystem 310 can be similarly informed (e.g., with an “investigate” message transmitted by the CAN to the SIU subsystem). Optionally, the CAN 105 can be configured to also deliver a “hold” message to the Claim Adjudication Subsystem indicating that the claim will be investigated.

Generally, the “investigate” message to the SIU Subsystem 310 results in the opening of a case within the SIU case management system (not shown). In some implementations, the “investigate” message can be generated by the CAN 105 such that it indicates the reason or reasons that the claim was flagged for investigation, along with reference to any relevant or associated claims. The routing determination and identification of relevant or associated claims can be identified by the CAN according to rules-based or machine learning algorithms. For example, a routing determination of a claim related to an appendectomy might reference a prior paid appendectomy claim from two years ago, with an indication that an appendectomy is considered once-in-a-lifetime procedure. It should be noted that the associated claims might have originally come from a different claim source, in which case the CAN 105 can be configured generate and provide a de-identified version of the associated claim. In addition or alternatively, the CAN 105 can be configured to verify whether a Business Associate Agreement (“BAA”) is in place allowing the claim source (e.g., Healthcare Claim Adjudicator 115A) to receive the PHI (protected health information) provided by the CAN.

Generally, when the “investigate” message to the SIU Subsystem 310 results in the opening of a case within the SIU case management system (not shown), the initial step in the investigation may be automated. In particular, the claim in question may be denied and an appropriate reason code associated with the denied claim, with the denied (zero-paid) claim transmitted to the provider through the normal channels (denied claims are a common outcome from the adjudication system). A given one of the reasons that accompany the “investigate” message can be mapped to standard denial reason codes (there are several hundred of these standard Claim Adjustment Reason Codes). By immediately denying payment on the claim, the Health Claim Adjudicator 115A satisfies prompt-pay statutes (stops the clock) and requests that the provider review and resubmit the claim with appropriate changes or additional information. After this initial step in the investigation, there are three possible actions by the provider:
1. Abandon the claim—The provider may recognize that the claim is inappropriate and should never have been submitted.
2. Resubmit the claim with proper coding—The provider may recognize that the initial claim was appropriate, but not properly coded.
3. Resubmit the claim with additional documentation—The provider may recognize that the initial claim was both appropriate and properly coded, but requires additional documentation (e.g., medical records) to justify payment in an unusual situation.
   The investigation proceeds based on the action chosen by the provider. If the provider abandons the claim, the investigation concludes when the deadline for the provider's response passes. If the claim is resubmitted with updated coding, the updated claim is once again analyzed by the CAN, the appropriate claim routing determination is made and the usual pay or investigate actions are enacted. If the claim is resubmitted with additional documentation, the claim is reviewed by a member of the SIU team and an appropriate decision is rendered.

At the conclusion of the investigation, the SIU Subsystem 310 can be configured to inform the Claim Adjudication Subsystem 305 of the “decision” (e.g., how much to pay and why), which can comprise transmission to the CAN 105. Similarly, if the SIU determines to not investigate a referred case, a decision message can be sent to the CAN and Claim-Adjudication Subsystem indicating that the claim should be paid and the reason for not investigating (e.g., insufficient resources).

Although the exemplary embodiments of the invention are described in the context of a pre-payment claim it should be understood that the particular timing of the analysis, scoring, or other claim processing functions (and potential subsequent investigation) can be performed at various stages in the claim-adjudication process including one or more of: prior to adjudication; following adjudication, but prior to payment; immediately following approval for payment; and at any time subsequent to payment.

### Exemplary Claim Analysis Processes

The operation of the system for processing healthcare claims and detecting FWA 100 and the various features and functions of the system will be further appreciated from the following discussion of exemplary methods for processing healthcare claims and detecting FWA in accordance with one or more embodiments of the invention.

As previously noted, in many cases, the claim details that flow from the healthcare claim sources identify the insured person and the patient by a member number that is associated with the particular proprietary product. It can be appreciated that each person may be assigned many member numbers at any point in time (e.g., dental coverage vs. medical coverage) and over a period of time (e.g., due to changing employers or an employer changing plans). Accordingly, the CAN 105 can be configured to uniquely identify each person by maintaining a mapping of the various identifiers and member numbers that may be associated with the person to a unique identifier, such as a social security number (“SSN”).

More specifically, the CAN 105 is configured to analyze the content of the received electronic claim detail record to identify information suitable for identifying the patient or insured person. For instance, the CAN 105 can be configured to extract text resembling a member ID number, social security number, name, employer, etc. and test the extracted information against a data store of patient/insured person information.

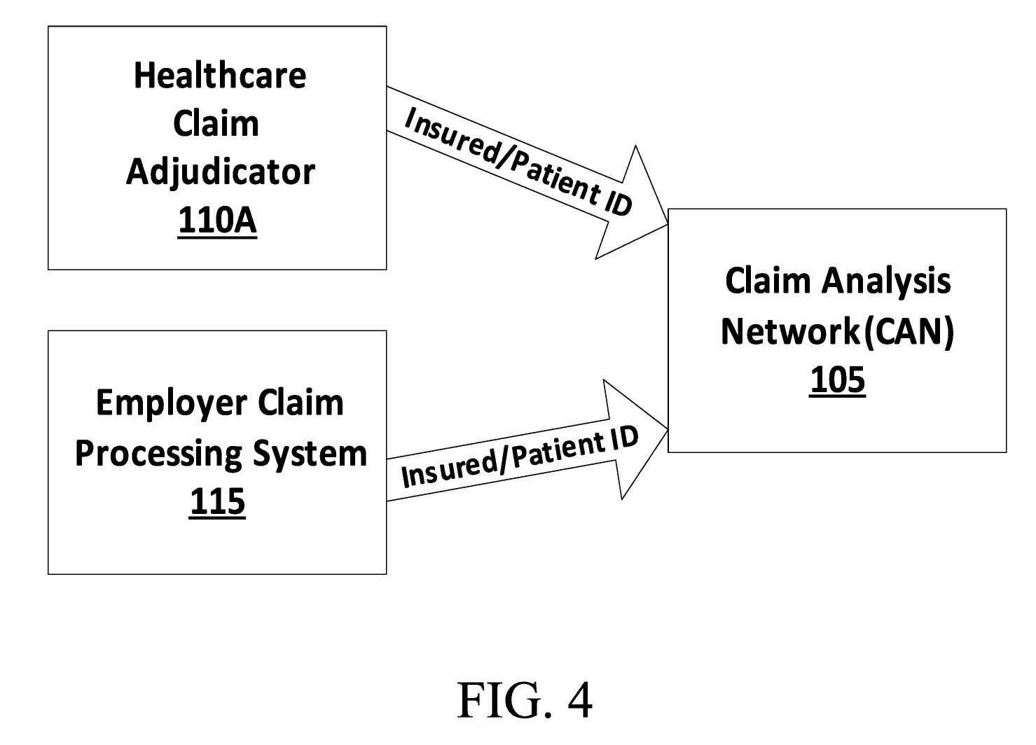

If each claim detail record that is received contains the insured and patient social security numbers, then no additional information is required for identification purposes beyond the claim feeds from the various claim sources. However, in some instances, unique identifiers are not provided with the claims. Accordingly, the CAN's identity mapping functionality can be supplemented by a separate feed of identifier mapping data that is received by the CAN 105, as shown in FIG. 4. FIG. 4 is a high-level diagram illustrating an exemplary data flow of identification information between the CAN 105 and the Healthcare Claim Adjudicator 115A and Employer System 115 in accordance with one or more embodiments of the invention. The identification feed may come from the healthcare claim adjudicator that is supplying the claims or another associated party, such as the employer that is paying for the insurance or claims. At a minimum, the identification feed associates an identifier that appears with the claim (e.g., a member number) with a unique identifier for the person (e.g., SSN). The identification feed can also contain additional information such as coverage dates, coverage details (e.g., deductibles, maximum coverage), patient demographic information and other metrics (e.g., participation in wellness programs). In some cases, the ancillary data can be used to enhance the analytic models and in other cases can be used to provide additional data dimensions for reporting functionality of the CAN.

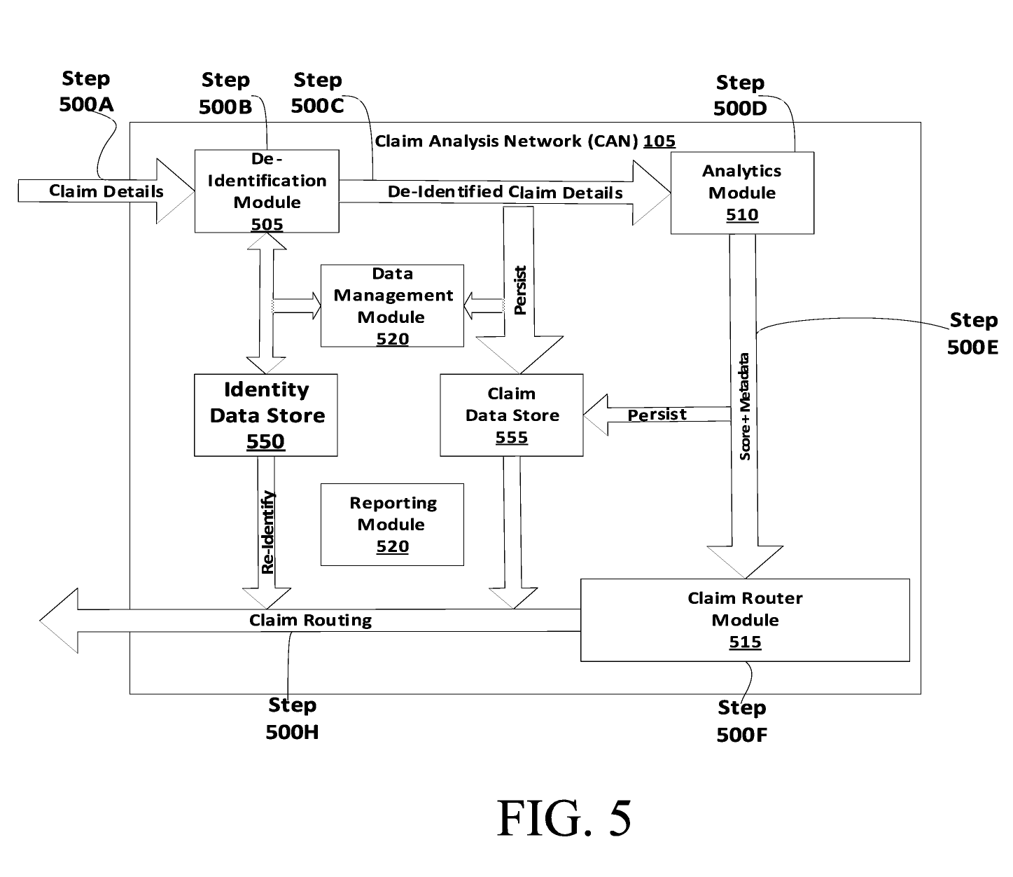

FIG. 5 is a high-level diagram illustrating a high-level system diagram of the CAN 105 and an exemplary data flow of claim detail information between the various functional elements of the CAN 105 in accordance with one or more embodiments of the invention.

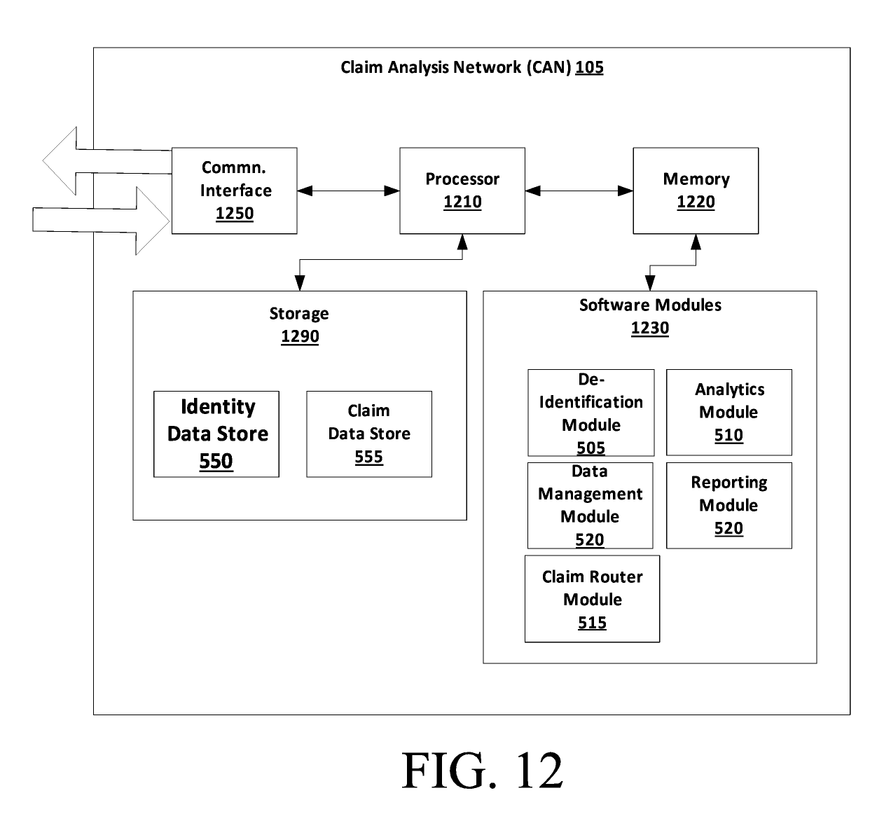

It can be appreciated that the CAN 105 can be arranged with various hardware and software components that facilitate operation of the system for processing healthcare claims and detecting FWA 100. These hardware components can include a processor, computer-readable non-transitory memory and storage devices and a communication interface enabling communication between the CAN 105 and any of the remote computing devices integrated with the system 100. Further description of the exemplary hardware components of the CAN 105 are provided herein in reference to FIG. 12.

As shown in FIG. 5, the CAN 105 comprises one or more functional modules or subsystems, including, for example, a de-identification module 505, an analytics module 510, a claim router module 515, a data management module 520 and a reporting module 525. The functional modules or subsystems can include hardware elements, program code such as a set of instructions implemented by a processor, or a combination of the foregoing.

Also shown in FIG. 5 are an identity data store 550 and a Claim Data Store 555. These data stores can be provided in a non-transitory computer-readable storage that is local to the CAN 105 or otherwise accessible to the CAN in a manner known to those of ordinary skill in the art (e.g., on data source 125 depicted in FIG. 1). It should be further appreciated that such local or remote storage can similarly store other data used in connection with the disclosed embodiments of the invention, for instance, information concerning patients and insured persons, participating employers, healthcare claim adjudicators, analytics provider information, as well as any rule-sets and analytical models used to analyze healthcare claims for FWA, as further described herein.

Continuing with the exemplary process illustrated in FIG. 5, the CAN 105 receives the claim details (Step 500A) for de-identification of the claims by the de-identification module 505 (Step 500B). During de-identification, the de-identification module 505 can be configured to analyze the received claim and extract identification (“ID”) data contained therein. The de-identification module can further be configured to, in conjunction with the data management module 520, update the identity data store 550 as appropriate based on the extracted ID data. Moreover, the de-identified claim can be similarly stored in the claim data store 555.

De-identification is performed in a manner that does not degrade the efficacy of the analytics. For example, the analytics do not benefit from access to the patient's name, but may benefit from access to related demographic data, such as gender, age and geographic location. The de-identification module 505 can be configured to consistently re-map identifying features for a person to specific opaque identifiers for that person. In addition, the de-identification module can be configured to provide gender and state of residence, while providing a filtered view of other demographic features of the patient such as date of birth and residence address. For example, date of birth data may be filtered to birth year up to 90 years prior to the claimed service and the residence address may be filtered to just the first two or three numerals in the zip code (only two digits in low-population zip codes). In this way, the de-identification process can be configured to provide important demographic data about the patient without the potential for disclosing the patient identity. In addition, to facilitate processing of the claim internally and by independent third-party systems, the de-identification module can be further configured to adapt and transform data according to formatting requirements, for instance, required analytics formats. The CAN 105 also implements standard data formats to facilitate sharing of information across independent platforms.

As further illustrated in FIG. 5, each de-identified claim can also be routed within the CAN 105 to the analytics module 510 (step 500C) for analysis resulting in a score and associated metadata gathered during the analysis of the claim (Step 500D). The analytics module can be further configured to store such information with the claim (e.g., in the claim data store) and send such information to the claim router module 515 (Step 500E) for further processing by the claim router module (Step 500F). The score represents the relative FWA risk associated with the claim and the metadata represents an explanation related to the score, as well as information regarding the particular analytics engine that performed the scoring. The claim router module 515 can be configured to perform the functions of re-identifying both the claim and score metadata. In addition, the claim router can further determine the claim routing necessary for the claim (e.g., pay or investigate) and output the claim routing decision (Step 500G) to the appropriate claim source/adjudicator.

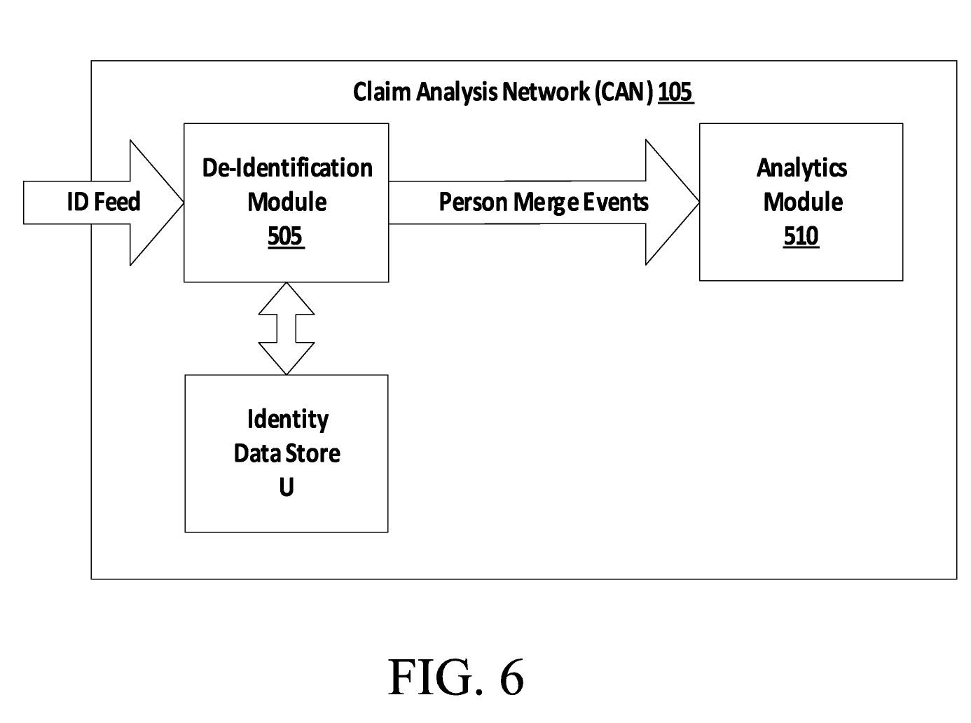

As previously noted, de-identification and initial claim processing can be informed by identification information supplied separate from the stream of claims. FIG. 6 is an exemplary processing and data flow diagram for processing such an ID feed received by the CAN 105 in accordance with one or more of the exemplary embodiments. In the exemplary embodiment shown in FIG. 6, the identity feed can be used by the CAN to update the identity data store. If an update results in the merging of two Person records by the de-identification module 505, the event can be emitted and routed to the analytics module 510. Merge events can result from the processing of claims prior to receiving a relevant identity feed. For example, if a claim is processed and the claim identifies the patient by member number, but that member number does not refer to a previously known person, then the de-identification module 505 and data management module 520 can create a new person record that is only identified by the member number. This type of processing can result in creation of multiple person records for an individual, for instance, based on the processing of claims with the person's dental member number and medical member number. However, when the identity feed is received and providing the social security number (SSN) that is associated with each member number is processed, the de-identification module 505 can be configured to determine that two or more member-number-only person records represent different aliases of a single person. When this occurs, the de-identification module 505 can be configured to record this relationship in the “Person records” maintained in the identity data store 550. In some implementations, one of the existing records can be chosen as the canonical record and updated with the SSN. In addition, a merge event or instruction can be emitted for each of the other person records that have been found to be an alias of the canonical record. Accordingly, any analytics modules that process the merge event can execute the appropriate merging operation in its internal data stores.

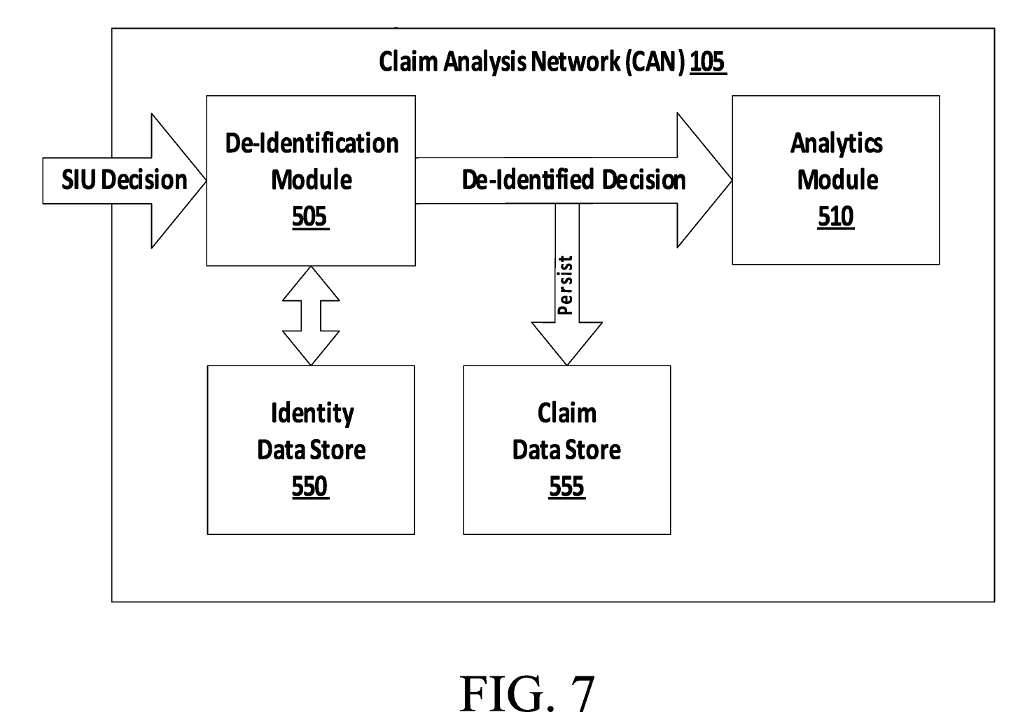

FIG. 7 is a data flow diagram further relating to the processing of a decision feed by the CAN 105 in accordance with one or more of the disclosed embodiments. As shown, a claim decision can be received by the CAN 105, for instance, from the SIU subsystem of a Healthcare Claim Adjudicator (e.g., SIU 310 shown in FIG. 3). The decision can consist of, for example and without limitation, a reference to a claim, the decision (e.g., to pay or to deny) and additional metadata that describes the reason for the decision as well as the resources (e.g., units of labor) consumed to arrive at the decision. In response, the decision and associated metadata can be de-identified by the de-identification module 505, persisted in the claim data store 555 using the data management module 520 and delivered to the analytics module 510 for further processing. For instance, the analytics module 510 can use the decision as feedback to improve the accuracy of the analytics over time.

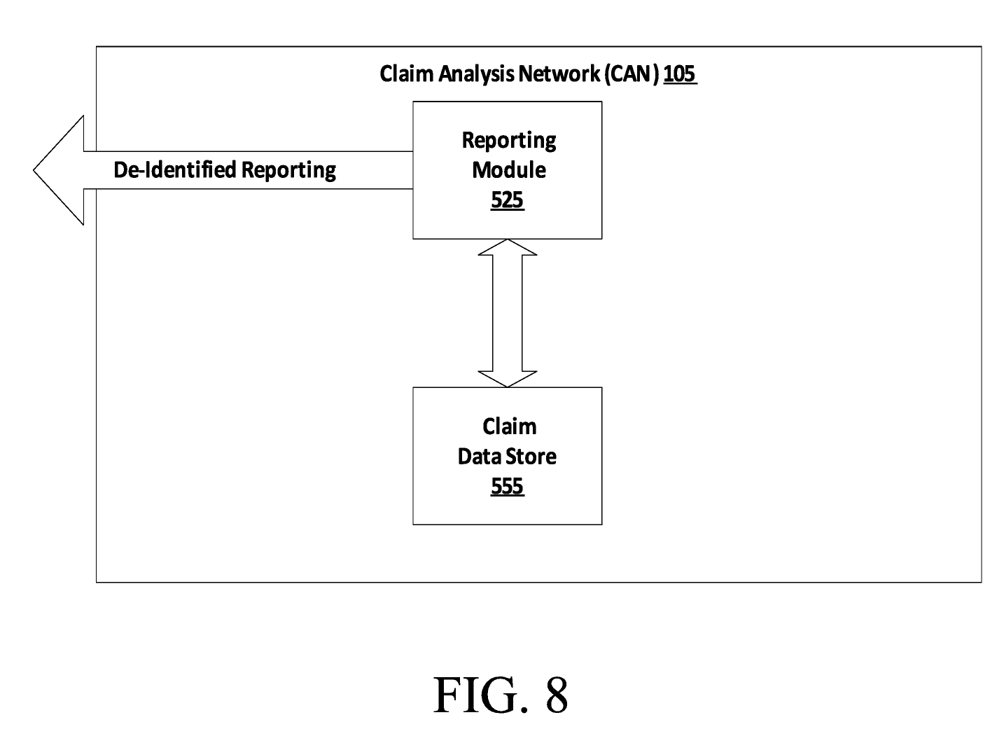

FIG. 8 is a process flow diagram illustrating the output of reports relating to claims by the CAN 105. In some implementations, the CAN 105 and, more specifically, the reporting module 525 can be configured to generate customer facing reports based on the customer's de-identified claims, de-identified scores (and score metadata) and de-identified decisions (and decision metadata). The information used to generate such reports can be derived from the claim data store 555 and the data stored therein for the particular customer. These reports can be tailored by the reporting module 525 to focus on various topics, including claim volume, scoring/routing (possible FWA identified and the portion routed for investigation), investigation decisions and marginal return on investigative resources. Each of these topics can be further broken down by various dimensions, such as plan type (e.g., management vs. union), claim type (e.g., medical or pharmacy), diagnosis, procedure, etc. Similar, the various metrics that are computed and reported by the CAN 105 can be computed in total as well as per-capita and also to show trends over time.

Likewise, reports across multiple customers' data can be computed and generated from the claim data store by the reporting module 525. These reports can be generated so as to compare a particular customer to industry averages; compare various segments of the industry; and the like.

In a similar way, the CAN 105 can be configured to implement internal-facing reporting processes using the information stored in the claim data store. For instance, such internal-facing reports can comprise an analysis of metrics that focus on operational issues, such as system volume and latency. In addition, the performance of the various analytics engines and algorithms employed by the analytics module can be characterized and compared by the CAN 105. In some implementations, the data generated in connection with these reports can be used to incrementally improve the efficacy of the analytics module 510 and/or the claim router module 515 over time. By way of further example, reports utilized for customer billing and analytics revenue-sharing can also be compiled by the CAN.

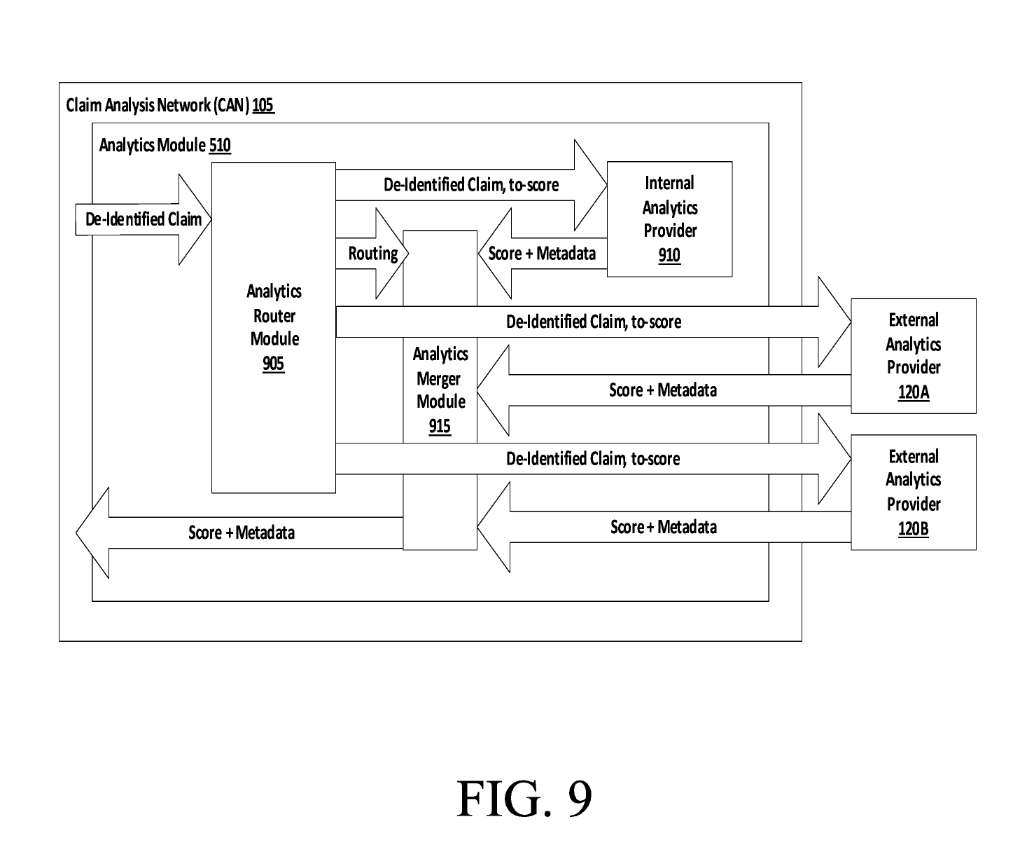

The analytics component of the CAN 105 will be further appreciated with reference to FIG. 9, which illustrates a detailed process and data flow diagram within the CAN 105 and, more specifically, the Analytics module 510 of the CAN in accordance with one or more of the disclosed embodiments. As shown in FIG. 9, the analytics component of the CAN 105 can be implemented as an analytics network that allows both internal and external (third-party) analytics providers to be utilized.

In an exemplary implementation, each de-identified claim is delivered to an analytics router 905 component of the greater analytics module 510. The analytics router can be configured to determine the routing of a claim (e.g., select zero or more of the analytics engines that will be instructed by the analytics router to score the claim) and instruct any selected analytics providers (e.g., by setting a to-score flag for a particular claim transmitted to selected analytics providers). The analytics router can also be configured to arrange transmission of the claim and any to-score flag or instruction to one or more of the analytics engine. In some configurations, the analytics router can be configured to provide each analytics provider with every claim, even if the analytics engine is not instructed to score the claim, so that each analytics engine has a complete record of every claim. In addition or alternatively to transmitting every claim, the analytics provider can be provided with access to a data store that compiles each claim and is updated in near-real time by the CAN. In some configurations, analytics providers can be provided with only a subset of claims or, by way of further example, only claims that the analytics provider is selected to score.

For a given claim that an analytics engine is instructed to score, the analytics engine can be configured to compute the score and associated metadata, which is returned to the CAN 105, as shown in FIG. 9. The returned results can be routed through the analytics merger module 915. The analytics merger module 915 can be configured to reconcile the routing (as defined by the analytics router 905) against the scores the particular claim has received from one or more of the analytics providers. For instance, as shown in FIG. 9, if the analytics router 905 instructs one or more of analytics engine 910 and external analytics engines 120A or 120B (or any combination of the foregoing) to score a particular claim, the Analytics merger 915 should receive a score and metadata from each so instructed analytics engine. When a prescribed number of scores for a given claim have been received, the analytics merger module 915 can be configured to apply the merging function to produce the final score and associated metadata for the claim. As noted previously, the final score and metadata can then be emitted from the analytics module 510 component of the CAN and inform the routing of a claim by the claim router module 515 discussed in relation to FIG. 5.

The foregoing features and functionality of the exemplary system for processing healthcare claims and detecting FWA 100 and the CAN 105 will be further appreciated with the additional discussion of the various components herein.

### De-Identification

A previously noted, strong identification is implemented by the CAN 105, supporting de-identification and re-identification. The goal of de-identification is to limit the propagation of protected health information (PHI) without compromising the efficacy of the analytics providers. The CAN de-identification operation is based on the “Safe Harbor” approach specified by the Department of Health and Human Services (HHS), as would be understood by those in the art. The basic principle is that the analytics providers need to know which claims relate to services for which patients, but they do not need to know who the actual person is. While the CAN receives detailed information, it can be configured to present only an opaque identifier, gender, birth year (showing a maximum age of 90 years), etc. in the de-identified version of the claim that is transmitted to the analytics providers.

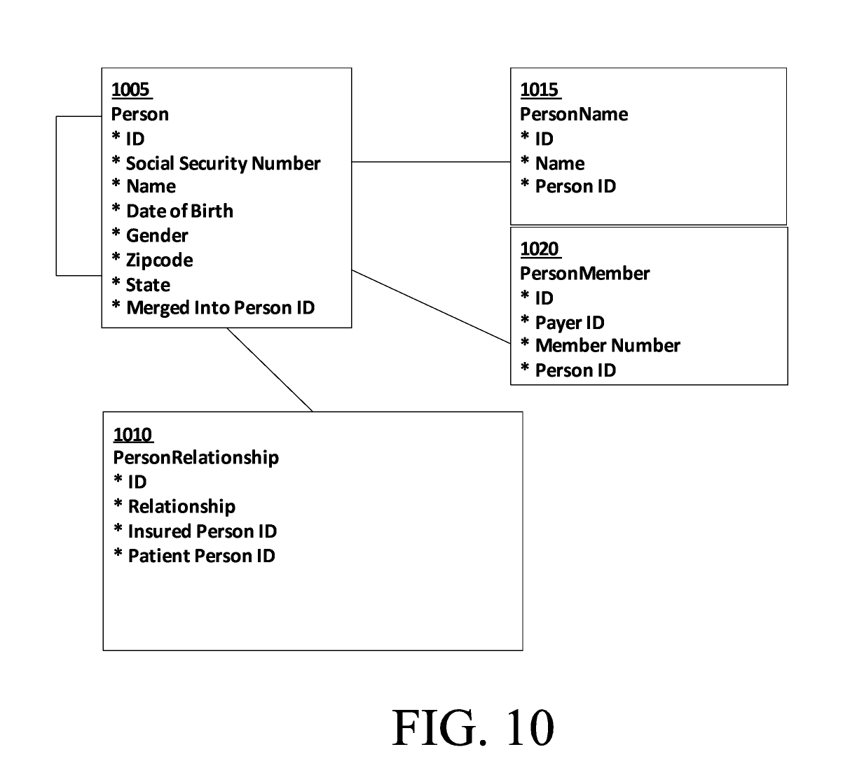

The de-identification process implemented by the de-identification module 505 can be supported by a data structure stored in the identity data store 550, such as a relational database. FIG. 10 illustrates an exemplary conceptual relational database schema diagram of a Person table 1005 and related tables in accordance with one or more of the embodiments of the invention. As shown, the relational schema can contain a Person table 1005, where each instance represents a physical person (e.g., patient and/or insured person). The Person table contains attributes that are generally considered to have a one-to-one relationship to a person in the real world, such as social security number, name, date of birth and gender. Additional attributes are included that represent the current value of attributes that tend to change infrequently, such as zip code and state. Each claim that is received and de-identified generally contains information about the insured person, the patient and the relationship of the patient to the insured person. This information can be stored in the PersonRelationship table 1010. In the real world, these relationships may change over time and appropriate additional records and updates are applied as appropriate, for instance, by the de-identification module 505 and/or data management module 520.

There are multiple ways to refer to the same person, such as names and member numbers. Accordingly, the CAN 105 can be configured to track all the various names that are used to refer to a person in the PersonName table 1015. Likewise, the CAN 105 can maintain a mapping of payer member number to person in the PersonMember table 1020.

As noted above, these tables can be populated while processing the ID feeds (e.g., from an employer) and can also be enhanced during claim processing. More specifically, there are several cases where the de-identification module 505 creates a new Person record and later determines that the new record can be referred to a pre-existing Person record. One example is when the CAN processes a claim that identifies a person via member number and the CAN does not have an existing mapping of that member number in the PersonMember table. In this case, the de-identification module 505 creates a Person record and a PersonMember record that contains the member information and refers to the new Person record. Later, the CAN receives an ID feed from the employer that contains an association between the member number and social security number. Based on such information, the de-identification module 505 can determine that the person having that social security number already exists in the Person table. For instance, by cross-referencing the member number and social security number with existing Person records. In response, the de-identification module can be configured to update the second Person record to refer to the canonical Person record (the one that is identified by the social security number). In addition, the de-identification module can also be configured to provide a Person Merge Event notification to the analytics providers so as to inform the analytics providers accordingly. Additional maintenance can also be performed by the de-identification module to make records in the related tables such as PersonName and PersonMember refer directly to the canonical Person record. In any case, any Person lookup that results in a record that has been merged into another Person record must be dereferenced (perhaps repeatedly) to retrieve the canonical Person record.

In some configurations, as each claim is de-identified, the de-identification module 505 can be configured to look up the canonical Person record, creating new records in the Person table and related tables as appropriate. In addition, the de-identified version of the claim can be constructed from the canonical Person and related attributes. For instance, the de-identified Person can be represented by the ID from the Person table rather than name, social security number or member number. In addition, all PHI in the claim that is not strictly required for the analytics can be cleansed by the CAN using the Safe Harbor method as defined by HHS. As a result, the claim can be made available to the analytics engines.

### Routing Claims for Analysis

As previously discussed in connection with FIG. 9, the primary functions of the analytics router 905 are: to determine for each claim the routing for the claim, e.g., which analytics provider(s) (if any) will be asked to score the claim; 2) arrange delivery of the claim to each appropriate analytics provider along with the appropriate “to-score” flag as determined by the analytics router 905.

The analytics router 905 can be configured to make the routing determination by analyzing the claim in view of one or more prescribed rules defining the particular circumstances for routing claims to one or more of the analytics engines. The basis for routing may be influenced by the claim source, the claim type (e.g., medical, dental) or other claim-related factors, the configuration and state of the analytics providers and past performance of the analytics provider. Some exemplary rules include, but are not limited to:
A particular claim source may choose to use a particular analytics provider or set of providers.
A particular analytics provider may only support particular claim types; that analytics provider would not be asked to score claims that it does not support.
The routing may be based (at least in part) on past performance, with analytics providers that previously have demonstrated higher accuracy for similar claims being more likely to be asked to score the claim. This type of routing may be based on a machine learning model that is trained on prior claims and associated claim decisions from an SIU.
The routing may be round-robin (or weighted round-robin) among the eligible analytics providers. In other words, consecutive claims are distributed to different analytics providers in an orderly fashion.
Multiple analytics providers may be selected to reduce the chance of receiving no response and having to retry later.
An analytics provider that otherwise might have been chosen may be skipped if recent claims that have been routed there have not received timely responses.
The routing may be influenced by contractual obligations, such as daily minimum or maximum claims.

As previously noted, the analytics engine configuration can allow for the analytics providers to receive a particular claim type while not scoring that claim type. Such a configuration can be useful when the analytics provider desires to accumulate claims to support the development of new analytics for that claim type.

### Merger of Independent Analytics Results

As previously discussed in connection with FIG. 9, the analytics merger module 915 has three main functions, namely, to join the responses to the asynchronous requests to score a claim that was transmitted to multiple analytics providers, to normalize the scores that are received and to compute the aggregate score and metadata.

With respect to joining, in one or more implementations, the analytics merger module 915 can be configured to perform the joining operation once all responses (scores) have been received from respective analytics providers assigned to score a particular claim. More typically, the analytics merger module can be configured with a timeout, so it does not have to wait until all analytics providers that were asked to score a claim return a response. In this way, if one of the several analytics providers is having operational issues that are delaying responses, the CAN 105 can continue to process claims. More specifically, there can be a timeout that is applied, and the analytics merger module can be configured to only wait for the prescribed maximum amount of time for the analytics providers to respond with a score; if the time is exceeded, whatever scores were received are fed into the merging function, the result of which is returned. In an alternative configuration, the analytics merger module can be configured to immediately return the first score that is received (e.g., to minimize scoring latency).

In regard to score normalization, as previously discussed in connection with FIG. 9, raw scores for a particular claim can received from the various analytics providers. Because the scores are defined to facilitate a relative ranking, a particular raw score value has no inherent correlation to a particular likelihood that investigation of the claim will result in reduced payment. Further, while the raw scores provide a way to order claims from a particular analytics provider, they do not allow for comparing between analytics providers. To solve this problem, the analytics merger module 915 can be configured to normalize the raw scores by applying a normalization mapping function to the received raw scores.

In some implementations, a variation of a standard normalization function, such as stanine or sten can be applied. Such functions are typically built upon a normal distribution. However, in practice analytic scoring engines might not produce a normal distribution limiting applicability of standard normalization functions. In addition or alternatively, and more a normalization mapping function that spreads the score more evenly across the range can be implemented.

In one or more exemplary embodiments, the normalization mapping function can be separately determined by the analytics merger module 915 for each analytics provider and each claim type (e.g., medical, dental, facility, pharmacy). The normalization mapping function can be computed automatically based on the raw score distribution of a recent set of claims and the function can be updated periodically. For example, a normalization mapping function can be recomputed on a daily basis based on the past seven days of claims. Alternatively, a normalization mapping function can be computed every 5,000 claims based on the most recent 10,000 claims that were scored.

A basic purpose of the normalization mapping is to spread the distribution of raw scores of the recent claims over the score range, say, zero to one thousand. More specifically, the recent raw scores can be sorted. The minimum raw score can then be mapped to a normalized score of zero and likewise the maximum raw score can be mapped to a normalized score of 999. The raw score that is found at the beginning of the first decile can be mapped to 0; the raw score that is found at the beginning of the second decile can be mapped to 100; etc. Within a decile, linear interpolation can be applied.

For purposes of illustration, assume that we are basing the normalization mapping function on a total of fifty raw scores, with the following table 1 including eleven scores representing the first two deciles plus one:

| Decile | Raw Score | Decile Boundary Mapping | Normalized Score |
|---|---|---|---|
| 3 | 350 | 200 | 200 |
| 2 | 310 | | 120 |
| 2 | 310 | | 120 |
| 2 | 305 | | 110 |
| 2 | 305 | | 110 |
| 2 | 300 | 100 | 100 |
| 1 | 275 | | 90 |
| 1 | 250 | | 80 |
| 1 | 225 | | 70 |
| 1 | 200 | | 60 |
| 1 | 50 | 0 | 0 |

### Table 1.

Values in the first decile can be linearly interpolated based on the 300→100 mapping and 50→0, as follows:

$${Score}_{normalized}^{decile 1} = ( {Score}_{raw} - 50 ) \frac{100 - 0}{300 - 50} + 0$$

Likewise, values in the second decile can be interpolated according to the following equation:

$${Score}_{normalized}^{decile 2} = ( {Score}_{raw} - 300 ) \frac{200 - 100}{350 - 300} + 100$$

In this way, a mapping function can be defined for each decile based on the recent distribution of raw scores. When a new raw score is received from an analytics provider, the corresponding normalization mapping function can be applied. To apply the mapping, the decile within the recent raw scores that were used for calculating the mapping is determined and the corresponding decile mapping function is applied to compute the normalized score. If the raw score is less than the minimum raw score from the recent raw scores, the minimum normalized score can be assigned, e.g., zero. Likewise, if the raw score is greater than the maximum raw score from the recent raw scores, the maximum normalized score can be assigned, e.g., 999. If a given analytics provider has a number of analytics functions that are applied to a type of claim (e.g., medical, dental), that analytics provider can be configured to normalize scores across their various analytics functions prior to returning the raw score to the CAN. This ensures that within a claim type, the analytics provider enables a consistent ranking of claims by score to determine the relative risk that is indicated for each claim.

With respect to computing aggregate results, as previously discussed in connection with FIG. 9, the analytics merger module 915 further performs the function of merging results from multiple different analytics engines for a particular claim. In general, the merging function computes an aggregate score and comprises a subset of the individual scores and their associated metadata as part of the final score metadata. For example, if two analytics providers are asked to score a claim, the merging function can take the maximum of the two normalized scores as the aggregate raw score and comprise both scores and their associated metadata in the reported metadata.

The analytics merger module 915 can be configured to perform the merging operation according to the particular requirements set forth by respective claim sources. For instance, different claim sources can require different merging function. Similarly, different merging functions can be required for different claim types. For example, one self-insured employer can choose a merging function that computes the aggregate raw score as the maximum of the normalized scores, while another employer may choose the mean of the normalized scores.

Similar to the normalization of individual raw scores described above, the analytics merger module 905 can also be configured to normalize the aggregate raw score, for instance, using the exemplary score normalization methods described above. In normalizing the aggregate score, the context for performing the normalization can be, for example, the claim source and claim type for which the merging function has been defined.

### Claim Routing

As previously discussed in connection with FIG. 5, the claim router module 515 is configured to determine, based on the score(s) and metadata for a claim received from the analytics module 510, whether a claim should be paid or should be investigated further due to indicia of FWA. In addition, the claim router module is configured to communicate scored claims to the appropriate claim adjudicator indicating which claims should be paid and which should be investigated further. Various algorithmic solutions can be implemented to determine based on the scored claims whether investigation or payment is appropriate.

For instance, in some implementations, the claim router module 515 can determine to investigate or pay a claim according to a return on investment (ROI) model. For example and without limitation, the ROI model can require investigation whenever the estimated return from doing the investigation is greater than the cost of doing the investigation for a given claim c

$_{claim}^{c}P_{deny}^{c}>$_{investigate}^{c}

where $_{claim} is the value of the claim, P_{deny} is the probability that investigation will result in denial of the claim and $_{investigate} is the investigation cost. Note that this non-limiting example is a simplified formula because it does not take into account the cases where investigation results in a reduced payment amount rather than an outright denial. Both P_{deny} and $_{investigate} can be estimated based on the normalized score and recent SIU decisions, along with SIU labor unit cost.

By way of further example, the claim router module 515 can determine to investigate or pay a claim according to a burden of proof (“BOP”) model. There are legal theories related to the Employee Retirement Income Security Act of 1974 (“ERISA”) that place a legal requirement to not make healthcare reimbursements unless there is proof that the claim is legitimate. Using the BOP approach, the claim router can be configured to recommend investigation whenever there is sufficient uncertainty with regard to the legitimacy of a given claim c, for instance using the following equation:

P_{deny}^{c}>P_{threshold}

where P_{deny} is the probability that investigation will result in denial or reduced payment of the claim and P_{threshold} is a fixed value.

The ROI and BOP methodologies have strong theoretical basis and are provided as non-limiting examples of possible approaches to determining.

A problem faced in the industry is that the investigative process is generally resource-constrained—there are not enough investigators available to investigate every questionable claim. Accordingly, the claim router module 515 can be configured to focus the available investigative resources on the most promising claims, although a sample of a wider spectrum of claims may be routed for investigation to support improved estimation of the volume of improper payments among the claims that are not routed for investigation.

More specifically, the claim router module 515 can be configured to route claims as a function of certain control variables concerning two important concepts. The first concept is claim prioritization, which is the process of determining the relative importance of investigating scored claims. The second concept is investigation volume, which is the primary control variable for how many claims are routed for investigation.

For instance, the algorithm for prioritizing claims in view of the foregoing concepts can be a function of one or more of: the assigned score(s) (e.g., normalized score), the corresponding payment amount for respective claims, as well as metrics relating to how efficiently a claim can be investigated, for instance, investigation volume or an estimated time to investigate (“TTI”).

A simplistic prioritization algorithm can include placing the scored claims in descending order of score. However, to such a simplistic formula can be less than optimal as a claim for $5 with a score of 950 can be assigned a higher priority to investigate than a claim for $50,000 with a score of 850. Another exemplary prioritization formula for claim adjudicator a and claim c is, for example:

$${P}_{c} = \frac{{Score}_{c} {Payment}_{c}}{{TTI}_{c}^{a}}$$

where Score is the normalized score, Payment is the payment amount, TTI is the estimated time to investigate (“TTI”). Higher values of P indicate higher priority to investigate. If insufficient TTI data is available in recent SIU decisions, the associated factor in the formula can be omitted. The product in the numerator of the foregoing prioritization formula creates a balance between the value of the claim and the likelihood the claim should not be paid. The denominator characterizes the estimated relative cost of investigation.

The metrics relating to investigation volume, such as the TTI value for a claim and a particular claim adjudicator can be calculated by the claim router module 515 according to feedback received for recent SIU decisions by an associated claim adjudicator. As mentioned previously in connection with FIG. 7, each SIU decision can contain actual TTI data for each claim that was investigated. In some implementations, the claim router module 515 can define a machine learning model for each claim adjudicator that is periodically updated with recent claim/TTI data queried from the claim store. The model can use various features of a claim to estimate the expected TTI for that claim, such as claim type, diagnosis, procedure, and the like.

While SIU resources are generally constrained, no SIU resources are required to make the initial response to the provider. In general, the metadata associated with a high scoring claim that is routed with an “investigate” message can be automatically mapped to an appropriate standard Claim Adjustment Reason Code (“CARC”). The claim source may generally implement an automated denial for each “investigate” message, returning the claim to the provider with a zero-payment amount and the appropriate CARC. Many of these denied claims are never resubmitted; if an incorrectly-coded claim is corrected, resubmitted and reanalyzed, it may be routed to “pay” and never require examination by SIU staff. There are significant classes of suspicious claims, however, that may rarely require human review and therefore the associated TTI is negligible or zero. In other words, even in the face of constrained SIU resources, many suspicious claims may still be routed for investigation and be properly resolved.

### Reporting

As previously discussed in connection with FIG. 8, the CAN 105 can be configured to generate customer facing reports. More specifically, reports can be provided to each claim source regarding the flow of the claim source's claims through the CAN. Exemplary metrics evaluated and detailed in such reports can include, without limitation, number of claims, claimed amount and paid amount. These metrics can be aggregated by claim type, score range, claim routing, investigation decision, etc. These aggregates are computed by timeframe to expose trends.

While every claim that is analyzed by the CAN 105 and found to be of a suspicious nature by one or more of the analytics may not actually be investigated, the CAN may be configured to estimate and report the reduction in payments that would have resulted if an investigation had been conducted. Based on the feedback information received from the various claim sources relating to the investigation of claims analyzed using the CAN 105, the reporting system of the CAN 105 can also maintain a model of inappropriate payments associated with claims that were not investigated (e.g., claims sent to STU that were “not investigated,” and claims that were suspicious but not sent to the STU for investigation). For example, if the CAN has observed that claims for home glucose test strips that trigger the high-frequency analytic result in a 75% reduction in paid amount when investigated by a particular claim adjudicator, the CAN could estimate that a similar, but not-investigated, claim would have resulted in a similar payment reduction had it been investigated.

The reporting system can utilize these models, for instance, to estimate the residual ERISA fiduciary exposure for a claim adjudicator and can be used to estimate the funds required to replenish an ERISA fund for claims for which it is not feasible to investigate (e.g., due to insufficient STU resources or negative ROI claims). A sampling of claims that are expected to have negative ROI may be routed to the STU to improve the accuracy of the estimates.

### Adding Participants to the Network

As previously noted, according to a salient aspect, the CAN 105 receives healthcare claims from a variety of different and independent healthcare claim sources such as the Healthcare Claim Adjudicators 110A-110B and Employer Claim System 115 depicted in FIG. 2, for example. Similarly, any number of third-party analytics providers providing respective analytics engines (e.g., Analytics Providers 120A and 120B) can be integrated with and used by the CAN to perform one or more of the claim analytics functions.

As new analytics providers joins the system, the analytics provider can be put on equal footing with the other existing analytics providers. In particular, the CAN 105 can be configured to seed the analytics engine with a feed of all prior de-identified claims. Furthermore, the new analytics engine can be prompted to score each claim. The scores on these historical claims can provide visibility into the efficacy of the analytics, which can then be used by the CAN in analytics routing decisions (e.g., using the Analytics Router Module 905). Additionally, the historical scores provide a basis for score normalization that may be applied to the new analytics provider as described above. In addition, after the historical claims are scored, the CAN 105 can also provide prior investigation decisions to the new analytics provider, for instance, so as to allow the new analytics provider to adjust its analytics systems and algorithms accordingly.

Similarly, new claim sources (e.g., employers, payers, healthcare claim adjudicators) can join the CAN. In connection with the integration process, the CAN 105 can receive, from the new claim source, a set of historical claims. Accordingly, the claims can be processed by the CAN 105, as previously described, to develop baseline scoring, analytics and routing methodologies for the particular claim source. For example, six years of historical claims can be provided as part of the on-boarding process. During the on-boarding process, these historical claims can be flagged as such by the CAN and while the claims are scored, they are not routed back to the claim source's SIU or adjudication subsystems. Instead, the scoring can be used by the CAN in the following ways: determine a scoring baseline and historical trend; perform an initial configuration of the claim routing module for the new claim source; and seed the analytics providers with past claims, so the analytics function with full efficacy from the first day of live claim scoring for the particular claim source.

Various claim sources and information sources and other such resources can be integrated with the CAN 105 so as to facilitate the operation of the system for processing healthcare claims and detecting FWA 100 including, for example and without limitation, “payers,” employers, analytics providers and the like.

Insurance companies are often referred to as “payers,” despite the fact that they are the source of funds only for a subset of the claims that they adjudicate and pay. The payers may use their adjudication systems both to support their own fully-insured products as well as act as a third-party administrator (“TPA”) for self-insured entities, such as employers. In the fully-insured case, the payer receives insurance premiums and pays claims. In the TPA case, the payer charges the employer an administration fee while the employer pays the claims that are approved (by the TPA) for payment.

A payer may join the CAN as a claim source for some or all of its claims. For example, the payer may choose to participate in the CAN for all of the fully-insured claims, but not for the TPA claims. Alternatively, the payer may choose to participate in the CAN for all claims. The claim source can filter claims delivered to the CAN according to such settings, in addition or alternatively, the CAN 105 can be configured to selectively process claims based on settings defined for the claim source, for instance, using a management reporting and controls interface provided by the CAN 105 to registered users.

In some implementations, when a payer acts as a claim source to the CAN, the payer integrates with the CAN as an adjudicator/SIU and, as such, can be provided with management reporting and controls the CAN configuration as it relates to the claim source (e.g., claim routing configuration). Accordingly, the payer can be responsible for fees associated with claim processing by the CAN.

By way of further example, a self-insured (“ERISA”) employer can also choose to participate in the CAN as a claim source. Generally, employers contract with a third-party administrator (“TPA”) to implement the provider networks, adjudicate claims, investigate claims, etc. The TPA administers the details while the employer pays the TPA and all claims that are approved for payment (although the TPA usually takes the responsibility for distributing payments to the providers).

When an employer or similar entity joins the CAN as a claim source, each of the employer's TPAs integrate with the CAN 105 as an adjudicator/SIU, while the employer receives management reports and controls the CAN configuration as it relates to the claim source (e.g., claim routing configuration). The employer is responsible for fees associated with claim processing by the CAN.

Analytics providers can similarly join the system 100, for example, to apply and monetize their analytics capabilities. Upon joining, the CAN 105 can be configured to provide an analytics provider with all de-identified claims and claim decisions previously processed using the CAN. In addition, the analytic provider receives a feed of all current de-identified claims and claim decisions that are processed using the CAN. The analytics provider can also be instructed by the CAN to score some or all of these claims.

The claim and decision data that are shared with analytics providers are extremely sensitive and valuable. Accordingly, restrictions on how the analytics provider may utilize the CAN data can be implemented.

### Ancillary Functions

The CAN 105 can also be configured to provide a number of ancillary functions using the information maintained in the course of operation of the system for processing healthcare claims and detecting FWA 100, including independent claim validation services, claim archival and retrieval and supplemental data analytics.

Claim adjudicators are responsible for investigating claims that are routed for investigation. Due to the historical behavior of many participants in that market, claim sources such as employers often desire an independent validation of their TPA's SIU efficacy. The CAN 105 can be configured to also provide independent claim investigation as an ancillary service that any claim source may utilize on a temporary or permanent basis. The independent claim investigation function operates by performing a post-payment analysis of a sample of the claim source's claims. While other study modes are possible, the sample of claims can be chosen from the set of claims that were routed for investigation by the claim adjudicator's SIU. The independent claim investigation service can provide, using the reporting system, a report or reports comparing the independently generated results with the actual decisions on the query set of claims. Such reports can provide similar metrics to the reports previously described and, for example, describe the overall findings and include case studies of individual claim findings.

For business and compliance reasons, claim sources generally archive (and occasionally retrieve) their claims for periods that are often six years or more from the present time. As an ancillary service, the CAN 105, which maintains historical records of claims, can be configured to provide the functions of claim archival and retrieval for claims processed through the CAN. In some implementations, the archived claims may not only consist of claim details received from the claim source, but also may be enhanced with raw and normalized scores, raw and normalized aggregate scores, claim routing, claim decision (if routed for investigation) and all associated scoring metadata stored in the claim data store 555.

Moreover, because the CAN is configured to implement strong identification across any number of claim types and claim sources, this creates a data set within the CAN that is uniquely rich in the healthcare industry. Accordingly, this data set may be leveraged, and analyzed using variety of models so as to provide deep insights across most aspects of healthcare.

FIG. 12 shows an example configuration of the CAN 105 in accordance with one or more of the disclosed embodiments. The other computing systems that implement the techniques described herein and comprise the system for processing healthcare claims and detecting FWA can be similarly realized.

As shown, the CAN 105 is arranged with various hardware and software components that enable operation of the system 100, including a hardware processor 1210, a memory 1220, storage 1290 and a communication interface 1250. The processor 1210 serves to execute software instructions that can be loaded into the memory 1220. The processor 1210 can comprise one or more processors, a multi-processor core, or some other type of hardware processor, depending on the particular implementation.

The memory 1220 and/or the storage 1290 are accessible by the processor 1210, thereby enabling the processor 1210 to receive and execute instructions stored on the memory 1220 and/or on the storage 1290. The memory 1220 can be, for example, a random access memory (“RAM”) or any other suitable volatile or non-volatile computer readable storage medium. In addition, the memory 1220 can be fixed or removable. The storage 1290 can take various forms, depending on the particular implementation. For example, the storage 1290 can contain one or more components or devices such as a hard drive, a flash memory, a rewritable optical disk, a rewritable magnetic tape, or some combination of the above. The storage 1290 also can be fixed or removable or remote such as cloud based data storage systems.

The one or more software modules 1230 are encoded in the storage 1290 and/or in the memory 1220. The software modules 1230 can comprise one or more software programs or applications having computer program code or a set of instructions executed in the processor 1210. In this way, the software modules 1230 are closely integrated with the operation and configuration of the physical hardware aspects of one or more implementations herein. Such computer program code or instructions for carrying out operational aspects of the systems and methods disclosed herein can be written in any combination of one or more programming languages. The program code can execute entirely on the CAN 105, partly on the CAN 105, as a stand-alone software package, partly on the CAN 105 and partly on a remote computer/device (e.g., Healthcare Claim Adjudicator 110A or External Analytics Provider 120A shown in FIG. 1), or entirely on such remote computing devices. In the latter scenario, the remote devices can be connected to the CAN 105 through any type of network, including a local area network (“LAN”) or a wide area network (“WAN”), or the connection can be made to an external computing system (for example, through the Internet using an Internet Service Provider).

During execution of the software modules 1230, the processor 1210 is configured to perform the various operations relating to the de-identification module 505, analytics module 510, claim router module 515, data management module 520 and reporting module 525, as described in detail above in relation to FIGS. 1 through 10.

It can also be said that the program code of the software modules 1230 and one or more of the non-transitory computer readable storage devices (such as the memory 1220 and/or the storage 1290) form a computer program product that can be manufactured and/or distributed in accordance with the present disclosure, as is known to those of ordinary skill in the art. It should be understood that in some illustrative embodiments, one or more of the software modules 1230 can be downloaded over a network to the storage 1290 from another device or system via communication interface 1250 for use within the system 100. In addition, it should be noted that other information and/or data relevant to the operation of the present systems and methods can also be stored on the storage 1290.

A communication interface 1250 is also operatively connected to the processor 1210 and can be any interface that enables communication between the CAN 105 and external devices, machines and/or elements. The communication interface 1250 includes, but is not limited to, a modem, a Network Interface Card (“NIC”), an integrated network interface, a radio frequency transmitter/receiver (e.g., Bluetooth, cellular, NFC), a satellite communication transmitter/receiver, an infrared port, a USB connection, and/or any other such interfaces for connecting CAN 105 to other computing devices and/or communication networks, such as private networks and the Internet. Such connections can include a wired connection or a wireless connection (e.g., using the IEEE 802.11 standard), though it should be understood that communication interface 1250 can be practically any interface that enables communication to/from the CAN 105.

At this juncture, it should be noted that although much of the foregoing description has been directed to systems and methods for processing healthcare claims and detecting FWA 100, the systems and methods disclosed herein can be similarly deployed and/or implemented in scenarios, situations, and settings far beyond the referenced scenarios. It can be readily appreciated that analyzing claims to identify fraud, waste and abuse can be effectively employed in practically any scenario where the assessment of likelihood of FWA, cost and risk is of value. It should be further understood that any such implementation and/or deployment is within the scope of the systems and methods described herein.

It is to be understood that like numerals in the drawings represent like elements through the several figures, and that not all components and/or steps described and illustrated with reference to the figures are required for all embodiments or arrangements. It should also be understood that the embodiments and/or arrangements of the systems and methods disclosed herein can be incorporated as a software algorithm, application, program, module, or code residing in hardware, firmware and/or on a computer useable medium (including software modules and browser plug-ins) that can be executed in a processor of a computer system or a computing device to configure the processor and/or other elements to perform the functions and/or operations described below. It should be appreciated that according to at least one embodiment, one or more computer programs or applications that when executed perform methods of the present invention need not reside on a single computer or processor, but can be distributed in a modular fashion amongst a number of different computers or processors to implement various aspects of the systems and methods disclosed herein.

Thus, illustrative embodiments and arrangements of the present systems and methods provide a computer implemented method, computer system, and computer program product for assessing a degree of risk in a prescribing behavior record. The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

What is claimed is:

1. A computer implemented method for algorithmically processing healthcare claim records to detect fraud, waste and abuse (“FWA”) and for enhancing the healthcare claim records using an independent and distributed claim analysis computing network, the method comprising:
electronically receiving healthcare claims at a claim analysis network computing device (“CAN”), the CAN having a memory, instructions in the form of code stored in the memory, a processor configured by executing the code, and the CAN having access to a claim data store containing a plurality of records concerning previously processed claims, and an identity data store containing a plurality of person records concerning persons associated with one or more of the previously processed claims, wherein the claims are received at the CAN over a network connection from a respective claim source among a plurality of independent claim sources;
processing a given received claim by the CAN, wherein the processing of the received claim comprises:
identifying, with the configured processor, a person identified in the received claim, and
generating, with the configured processor in the claim data store, a claim record based on the received claim;
analyzing, with the configured processor using an analytics network, the claim record against a set of rules pertaining to indicators of FWA and generating one or more results based on the analysis, wherein the analytics network comprises a plurality of analytics engines;
automatically enhancing the claim record in the claim data store according to the one or more generated results;
generating, using the configured processor, a routing decision for the claim based on the one or more results and with respect to one or more routing rules, wherein the routing decision is selected from the group consisting of:
a first routing decision directing a respective processing subsystem to pay the received claim, and
a second routing decision directing the received claim to an investigative processing subsystem (“SIU”) thereby prompting further investigation of the received claim using the SIU; and
distributing, using the configured processor, the enhanced claim record to a respective processing subsystem of a respective claim source according to the routing decision, thereby prompting adjudication of the claim by the respective claim source.

2. The method of claim 1, further comprising:
merging, using the code executing in the processor, the one or more generated results according to a set of normalization rules, wherein the set of normalization rules are defined according to a plurality of previously processed claims, and wherein the routing decision is based on the merged results.

3. The method of claim 1, further comprising:
in response to receipt of a final claim determination from the respective claim source concerning the adjudication of the received claim, automatically enhancing the claim record in the claim data store based on the received claim determination, and updating one or more rules selected from the group consisting of: the normalization rules, the routing rules and the set of rules pertaining to indicators of FWA.

4. The method of claim 1, wherein processing of the claim record comprises:
generating, with the configured processor according to the identity data store, a de-identified version of the received claim, wherein de-identification comprises remapping personally identifying features of the received claim to one or more specific opaque identifiers associated with the identified person in the identity data store; and
storing the de-identified version of the received claim in the claim record, and wherein the analyzing step is performed on the de-identified claim record.

5. The method of claim 1, further comprising:
determining, based on the identity record and the claim record, whether any previously processed claims relate to the identified person, and wherein the analyzing step is performed based on one or more previously processed claims that relate to the identified person.

6. The method of claim 1, wherein the analytics network comprises at least one analytics engine that is configured locally at the CAN and at least one remote analytics engine that is independent of the CAN.

7. The method of claim 1, wherein the step of analyzing the received claim using the analytics network, comprises:
selecting, with the configured processor, one or more analytics engines from among the plurality of analytics engines;
instructing, with the configured processor, the selected one or more analytics engines to analyze at least the claim record, wherein each of the one or more analytics engines are configured to independently analyze the claim record and generate a respective result; and
receiving, with the configured processor from the one or more selected analytics engines, the respective results.

8. The method of claim 7, wherein the step of analyzing the received claim using the analytics network, further comprises:
providing each of the plurality of analytics engines access to the claim record irrespective of whether such analytics engines are selected to score the claim record, thereby enabling analysis of other received claims by any of the plurality of analytics engine based on the received claim.

9. The method of claim 7, wherein the one or more analytics engines are selected according to analytics routing criteria selected from the group consisting of: a type of the received claim, a source of the received claim, and performance metrics for respective analytics engines.

10. The method of claim 2, wherein a plurality of results is generated by the analytics network, and wherein each result comprises a score representing a risk of FWA for the received claim and metadata representing pertinent information relating to the score of the received claim.

11. The method of claim 10, wherein the merging step is performed based on a plurality of previously processed claims and irrespective of whether such previously processed claims relate to the received claim.

12. The method of claim 10, wherein the merging step comprises:
normalizing each received score based on a respective normalization mapping function, wherein each respective normalization mapping function is automatically generated for a respective analytics engine based on a distribution of scores generated by the respective analytics engine for a plurality of previously processed claims, and wherein the normalization mapping function is automatically updated periodically by the CAN; and
generating an aggregated score for the received claim based on each normalized score.

13. The method of claim 1, wherein the routing decision is determined according to a prioritization algorithm that is a function of the generated result for the received claim, a value of the received claim and an estimated cost of investigating the received claim.

14. The method of claim 13, wherein generating the routing decision further comprises:
calculating the estimated cost of investigating the received claim specifically for a particular claim source that provided the received claim;
calculating the value of the received claim based on the received claim details; and
calculating a routing score as a function of the calculated estimated cost, the calculated value and the received result; and
generating one of the first routing decision and the second routing decision as a function of the calculated value.

15. A computer implemented system for algorithmically processing healthcare claim records to detect fraud, waste and abuse (“FWA”) and for enhancing the healthcare claim records using an independent and distributed claim analysis computing network, the method comprising:
a claim analysis network server (“CAN”) for processing healthcare claims, the CAN including a memory having stored instructions in the form of code, a hardware processor configured by executing the code, and a communications interface, wherein the CAN is configured to receive the one or more claims over a network connection from a respective claim source among a plurality of claim sources, and wherein the CAN has access to a claim data store containing a plurality of records concerning previously processed claims, and an identity data store containing a plurality of person records concerning persons associated with one or more of the previously processed claims;
an analytics network comprising one or more analytics engines selected from the group consisting of: an analytics engine that is configured locally at the CAN and a remote analytics engine; and
the CAN further comprising a plurality of functional modules implemented by the processor executing the instructions to process a given received claim, including:
a de-identification module operative to identify, using the identity data store and claim data store, a person identified in the received claim and generate a de-identified version of the claim,
a data management module operative to generate a claim record in the claim data store based on the received claim and enhance the claim record according to further analysis of the received claim using the CAN,
an analytics module operative to coordinate the analysis of the claim record by one or more analytics engines of the analytics network, wherein the analytics engines are configured to analyze the claim record according to a set of rules pertaining to indicators of FWA and respectively generate a result based on the analysis,
a claim router module operative to generate a routing decision for the received claim, the routing decision including one or more of: a first routing decision directing a respective processing subsystem to pay the received claim, and a second routing decision directing an investigative processing subsystem to further investigate the received claim, wherein the routing decision generated according to a prioritization algorithm that is a function of the merged score for the received claim, a value of the received claim and an estimated cost of investigating the received claim, and
a communication module operative to configure the processor to, based on the routing decision, distribute the claim record and the routing decision to an appropriate processing subsystem of a respective source of the received claim.

16. The system of claim 15, wherein the de-identification module is further operative to generate a de-identified claim record, wherein de-identification comprises remapping personally identifying features of the received claim to one or more specific opaque identifiers associated with the identified person in the identity data store.

17. The system of claim 15, wherein the analytics module is further operative to select one or more analytics engines from among the plurality of analytics engines according to a set of analytics routing criteria and instruct the selected one or more analytics engines to analyze the claim record and generate a respective result comprising a score representing a risk of FWA for the received claim and metadata representing pertinent information relating to the score of the received claim.

18. The system of claim 17, wherein the merger module is further operative to merge a plurality of results generated by a plurality of selected analytics engines according to a set of normalization rules that are specifically defined for the plurality of selected analytics engines.

19. The system of claim 18, wherein merger module is further operative to merge the plurality of results by normalizing each received score based on a respective normalization mapping function and calculating an aggregated score for the received claim based on each normalized score, wherein each respective normalization mapping function is automatically generated by the merger module for a respective analytics engine based on a distribution of scores generated by the respective analytics engine for a plurality of previously processed claims, and wherein the normalization mapping function is automatically updated periodically by the CAN.

20. The system of claim 15, wherein the claim router module generates the routing decision according to a prioritization algorithm that is a function of the generated result for the received claim, a value of the received claim and an estimated cost of investigating the received claim.
